(19) United States
(12) Patent Application Publication
(10) Pub. No.: US 2021/0269563 A1
(43) Pub. Date: Sep. 2, 2021

(54) DECORATIVE FILM FOR MOLDING, METHOD FOR PRODUCING SAME, MOLDED ARTICLE, AND MOLDING METHOD

(71) Applicant: FUJIFILM CORPORATION, Tokyo (JP)

(72) Inventors: Yuichi HAYATA, Kanagawa (JP); Takeshi HAMA, Kanagawa (JP); Nobuhiko ICHIHARA, Kanagawa (JP); Yujiro YANAI, Kanagawa (JP)

(21) Appl. No.: 17/322,821

(22) Filed: May 17, 2021

Related U.S. Application Data
(63) Continuation of application No. PCT/JP2019/048974, filed on Dec. 13, 2019.

(30) Foreign Application Priority Data
Dec. 14, 2018 (JP) 2018-234492
May 24, 2019 (JP) 2019-097758

(51) Int. Cl. C08F 20/30; B29C 51/14; B29C 45/14; C08F 22/20; C08J 5/18

(52) U.S. Cl. CPC C08F 20/30; B29C 51/14; B29C 45/14688; C08J 2335/02; C08J 5/18; B29K 2995/0037; C08J 2333/14; C08F 22/20

(57) ABSTRACT

Provided are a decorative film for molding including a cholesteric liquid crystal layer on a base material, in which the cholesteric liquid crystal layer is a layer formed by curing a liquid crystal composition which includes, with respect to a total solid content of the liquid crystal composition, 25% by mass or more of a cholesteric liquid crystal compound having one ethylenic unsaturated group or one cyclic ether group; a molded product using the decorative film for molding; and a molding method.

### CROSS-REFERENCE TO RELATED APPLICATIONS

This application is a Continuation of International Application No. PCT/JP2019/048974, filed Dec. 13, 2019, which claims priority to Japanese Patent Application No. 2018-234492, filed Dec. 14, 2018, and Japanese Patent Application No. 2019-097758, filed May 24, 2019. Each of the above applications is hereby expressly incorporated by reference, in its entirety, into the present application.

### BACKGROUND OF THE INVENTION

### 1. Field of the Invention

The present disclosure relates to a decorative film for molding, a method for manufacturing the same, a molded product, and a molding method.

### 2. Description of the Related Art

The surface of base materials such as paper, wood, plastic, metal, glass, inorganic material, and the like is coated to protect the surface by imparting various performances such as hardness, scratch resistance, abrasion resistance, chemical resistance, organic solvent resistance, and the like, and is painted for the purpose of designability.

In addition, a coating agent is applied to the surface of the molded product after molding for the purpose of protecting the surface of plastic molded products used for cases of home appliances, personal computers, mobile phones, and the like, and painting is performed for the purpose of designability.

In recent years, instead of the above-described coating or painting, a method of transferring a decorative layer to a molded product by a step of preparing a decorative layer as a decorative film for molding, placing the decorative film for molding on a mold, and then molding the decorative film for molding using a resin for molding.

Examples of a decorative film in the related art include decorative films disclosed in JP2014-019064A.

JP2014-019064A discloses a decorative film including an adhesive layer, a decorative layer formed from a base paint, and a thermoplastic film layer, in which the base paint contains 12 to 80 parts by mass of a flaky metal powder (B) having an average particle diameter of 15 to 50 μm and 1 to 25 parts by mass of spherical particles (C) having an average particle diameter of 2 to 20 μm with respect to 100 parts by mass of the solid content of a film-forming resin (A) including an acrylic resin emulsion (A-1), and the base paint is a water-based metallic paint in which the usage ratio of the flaky metal powder (B) and the spherical particles (C) is 15:1 to 2:1.

### SUMMARY OF THE INVENTION

An object to be achieved by the embodiment of the present invention is to provide a decorative film for molding, which has a small change in reflectance after molding, and a method for manufacturing the same.

An object to be achieved by another embodiment of the present invention is to provide a molded product using the above-described decorative film for molding, and a molding method.

The methods for achieving the above-described objects include the following aspects.

<1> A decorative film for molding comprising:

a cholesteric liquid crystal layer on a base material,

in which the cholesteric liquid crystal layer is a layer formed by curing a liquid crystal composition which includes, with respect to a total solid content of the liquid crystal composition, 25% by mass or more of a cholesteric liquid crystal compound having one ethylenic unsaturated group or one cyclic ether group.

<2> The decorative film for molding according to <1>, further comprising: a colored layer between the base material and the cholesteric liquid crystal layer.

<3> The decorative film for molding according to <1>, further comprising:

a colored layer on the cholesteric liquid crystal layer on a side opposite to a side provided with the base material.

<4> The decorative film for molding according to any one of <1> to <3>,

in which the liquid crystal composition includes, with respect to the total solid content of the liquid crystal composition, 25% by mass or more of a cholesteric liquid crystal compound having one ethylenic unsaturated group.

<5> The decorative film for molding according to any one of <1> to <4>,

in which the liquid crystal composition includes a polyfunctional polymerizable compound.

<6> The decorative film for molding according to any one of <1> to <5>,

in which the decorative film for molding has two or more cholesteric liquid crystal layers.

<7> The decorative film for molding according to any one of <1> to <6>,

in which the decorative film for molding is a decorative film for molding used for an exterior of an automobile.

<8> The decorative film for molding according to any one of <1> to <6>,

in which the decorative film for molding is a decorative film for molding used for a housing panel of an electronic device.

<9> A method for manufacturing a decorative film for molding, comprising:

a step of preparing a liquid crystal composition which includes, with respect to a total solid content of the liquid crystal composition, 25% by mass or more of a cholesteric liquid crystal compound having one ethylenic unsaturated group or one cyclic ether group;

a step of applying the liquid crystal composition to a base material to form a liquid crystal composition layer; and

a step of curing the liquid crystal composition layer to form a cholesteric liquid crystal layer.

<10> A molded product obtained by molding the decorative film for molding according to any one of <1> to <8>.

<11> A molding method comprising:

a step of molding the decorative film for molding according to any one of <1> to <8> or a decorative film for molding, which is manufactured by the method for manufacturing a decorative film for molding according to <9>.

According to the embodiment of the present invention, it is possible to provide a decorative film for molding, which has a small change in reflectance after molding, and a method for manufacturing the same.

According to another embodiment of the present invention, it is possible to provide a molded product using the above-described decorative film for molding, and a molding method.

### BRIEF DESCRIPTION OF THE DRAWINGS

FIG. 1 is a schematic cross-sectional view schematically showing an example of a shape of a molded article.

FIG. 2 is a schematic front view schematically showing another example of a shape of a molded article.

FIG. 3 is a schematic cross-sectional view schematically showing another example of the shape of the molded article.

### DESCRIPTION OF THE PREFERRED EMBODIMENTS

Hereinafter, the contents of the present disclosure will be described in detail. The description of constituent elements below is made based on representative embodiments of the present disclosure in some cases, but the present disclosure is not limited to such embodiments.

In the present specification, the numerical ranges shown using “to” indicate ranges including the numerical values described before and after “to” as a lower limit value and an upper limit value.

In numerical ranges described in stages in the present specification, an upper limit value or a lower limit value described in one numerical range may be replaced with an upper limit value or a lower limit value of a numerical range described in another stage. In addition, in the numerical ranges described in the present specification, the upper limit value or the lower limit value of the numerical ranges may be replaced with the values shown in examples.

Furthermore, in the present specification, in a case where a plurality of substances corresponding to each component in a composition is present, the amount of each component in the composition means the total amount of the plurality of substances present in the composition, unless otherwise specified.

In the present specification, the term “step” includes not only the independent step but also a step in which intended purposes are achieved even in a case where the step cannot be precisely distinguished from other steps.

In the present specification, the “total solid content” refers to a total mass of components obtained by removing a solvent from the whole composition of the composition. In addition, the “solid content” is a component obtained by removing a solvent as described above, and for example, the component may be solid or may be liquid at 25° C.

In a case where substitution or unsubstitution is not noted in regard to the notation of a “group” (atomic group) in the present specification, the “group” includes not only a group not having a substituent but also a group having a substituent. For example, the concept of an “alkyl group” includes not only an alkyl group not having a substituent (unsubstituted alkyl group) but also an alkyl group having a substituent (substituted alkyl group).

In addition, in the present disclosure, “% by mass” has the same definition as that for “% by weight”, and “part by mass” has the same definition as that for “part by weight”.

Furthermore, in the present disclosure, a combination of two or more preferred aspects is a more preferred aspect.

In addition, the weight-average molecular weight (Mw) and the number-average molecular weight (Mn) in the present disclosure are molecular weights in terms of polystyrene used as a standard substance, which are detected by using a solvent tetrahydrofuran (THF), a differential refractometer, and a gel permeation chromatography (GPC) analyzer using TSKgel GMHxL, TSKgel G4000HxL, and TSKgel G2000HxL (all trade names manufactured by Tosoh Corporation) as columns, unless otherwise specified.

Hereinafter, the present disclosure will be described in detail.

(Decorative Film for Molding)

The decorative film for molding (hereinafter, also simply referred to as a “decorative film”) according to an embodiment of the present disclosure includes a cholesteric liquid crystal layer on a base material, in which the cholesteric liquid crystal layer is a layer formed by curing a liquid crystal composition which includes, with respect to a total solid content of the liquid crystal composition, 25% by mass or more of a cholesteric liquid crystal compound having one ethylenic unsaturated group or one cyclic ether group.

In addition, the decorative film for molding according to the embodiment of the present disclosure can be used for various purposes, and examples thereof include interior and exterior of automobiles, interior and exterior of electric appliances, and packaging containers. Among these, the decorative film for molding according to the embodiment of the present disclosure is suitably used for the interior and exterior of automobiles, and is particularly suitably used for the exterior of automobiles. In addition, the decorative film for molding according to the embodiment of the present disclosure is suitably used for a housing panel of an electronic device.

In decorative films for molding in the related art, such as the decorative film for molding disclosed in JP2014-019064A, the present inventors have found that stretching during molding causes a large change in reflectance, therefore a visible color difference between the stretched portion and unstretched portion occurs and problems such as color unevenness occur.

As a result of intensive research conducted by the present inventors, it has been found that a decorative film for molding having a small change in reflectance after molding can be provided by employing the above-described configuration.

The mechanism of the excellent effects obtained by employing the above-described configuration is not clear, but is presumed as follows.

Since the cholesteric liquid crystal layer is a layer formed by curing a liquid crystal composition which includes, with respect to a total solid content of the liquid crystal composition, 25% by mass or more of a cholesteric liquid crystal compound having one ethylenic unsaturated group or one cyclic ether group, it is presumed that a decorative film for molding having excellent stretchability, a small change in alignment and alignment pitch in the cholesteric liquid crystal layer even in a case of being stretched, and a small change in reflectance after molding is obtained.

In addition, although the decorative film disclosed in JP2014-019064A has brightness, the decorative film has a design in which granular metal powder is viewed even before molding, which lacks uniformity in brightness.

By employing the above-described configuration, the decorative film for molding according to the embodiment of the present disclosure has excellent stretchability, a small change in alignment and alignment pitch in the cholesteric liquid crystal layer even in a case of being stretched, and excellent uniformity in brightness not only before molding but also after molding.

Furthermore, since the decorative film for molding according to the embodiment of the present disclosure includes the cholesteric liquid crystal layer, a color such as a structural color can be viewed, a change in color depending on the viewing angle and the viewed color itself can be adjusted, and the designability is also excellent.

Hereinafter, the decorative film for molding according to the embodiment of the present disclosure will be described in detail.

<Base Material>

The decorative film for molding according to the embodiment of the present disclosure has a base material.

As the base material, a known base material in the related art, as a base material used for molding such as three-dimensional molding and insert molding, can be used without particular limitation and may be appropriately selected depending on the application of the decorative film, suitability for insert molding, and the like.

In addition, the shape and material of the base material are not particularly limited and may be appropriately selected as desired, but from the viewpoint of ease of insert molding and chipping resistance, a resin base material is preferable, and a resin film base material is more preferable.

Examples of the base material include a resin film including a resin such as a polyethylene terephthalate (PET) resin, a polyethylene naphthalate (PEN) resin, an acrylic resin, a urethane resin, a urethane-acrylic resin, a polycarbonate (PC) resin, an acrylic-polycarbonate resin, triacetyl cellulose (TAC), cycloolefin polymer (COP), and acrylonitrile/butadiene/styrene copolymer resin (ABS resin).

Among these, from the viewpoint of moldability and strength, at least one resin film selected from the group consisting of a PET resin, an acrylic resin, a urethane resin, a urethane-acrylic resin, a PC resin, an acrylic-polycarbonate resin, and a polypropylene resin is preferable, and at least one resin film selected from the group consisting of an acrylic resin, a PC resin, and an acrylic-polycarbonate resin is more preferable.

In addition, the base material may be a laminated resin base material having two or more layers. Preferred examples of the laminated resin base material include an acrylic resin/polycarbonate resin laminated film.

The base material may contain other additives as necessary.

Examples of such additives include lubricants such as mineral oil, hydrocarbons, fatty acids, alcohols, fatty acid esters, fatty acid amides, metallic soaps, natural waxes, and silicone; inorganic flame retardants such as magnesium hydroxide and aluminum hydroxide; organic flame retardants such as a halogen-based flame retardant and a phosphorus-based flame retardant; organic or inorganic fillers such as metal powder, talc, calcium carbonate, potassium titanate, glass fibers, carbon fibers, and wood powder; additives such as an antioxidant, a UV inhibitor, a lubricant, a dispersant, a coupling agent, a foaming agent, and a colorant; and engineering plastics other than the above-described resins, such as a polyolefin resin, a polyester resin, a polyacetal resin, a polyamide resin, and a polyphenylene ether resin.

As the base material, a commercially available product may be used.

Examples of the commercially available product include TECHNOLLOY (registered trademark) series (acrylic resin film or acrylic resin/polycarbonate resin laminated film, manufactured by Sumitomo Chemical Co., Ltd.), ABS films (manufactured by Okamoto Industries, Inc.), ABS sheets (manufactured by SEKISUI SEIKEI CO., LTD.), Teflex (registered trademark) series (PET film, manufactured by TEIJIN FILM SOLUTIONS LIMITED), Lumirror (registered trademark) easily moldable type (PET film, manufactured by TORAY INDUSTRIES, INC), and Purethermo (polypropylene film, manufactured by Idemitsu Unitech Co., Ltd.).

The thickness of the base material is determined depending on the application of the produced molded product, and handleability of the sheet, which is not particularly limited, but is preferably 1 μm or more, more preferably 10 μm or more, still more preferably 20 μm or more, and particularly preferably 50 μm or more. In addition, the thickness of the base material is preferably 500 μm or less, more preferably 450 μm or less, and particularly preferably 200 μm or less.

<Cholesteric Liquid Crystal Layer>

The decorative film for molding according to the embodiment of the present disclosure has a cholesteric liquid crystal layer on the base material.

In addition, the cholesteric liquid crystal layer is a layer formed by curing a liquid crystal composition which includes, with respect to the total solid content of the liquid crystal composition, 25% by mass or more of a cholesteric liquid crystal compound having one ethylenic unsaturated group or one cyclic ether group.

From the viewpoint of exerting the effects of the present disclosure more, the decorative film for molding according to the embodiment of the present disclosure is preferably a decorative film for viewing through the cholesteric liquid crystal layer, and more preferably a decorative film for viewing at least one of colored layers described later through the cholesteric liquid crystal layer.

In addition, it is not needed for the cholesteric liquid crystal layer in the decorative film for molding according to the embodiment of the present disclosure to be in directly contact with the base material as long as the cholesteric liquid crystal layer is provided on the base material, and for example, the cholesteric liquid crystal layer may be provided on the base material through another layer such as a colored layer described later.

In the decorative film for molding according to the embodiment of the present disclosure, by changing at least one selected from the group consisting of the pitch of a helical structure, refractive index, and thickness of the cholesteric liquid crystal layer, it is possible to adjust the change in color depending on the viewed angle, and the viewed color itself. The pitch of the helical structure can be easily adjusted by changing the addition amount of a chiral agent. More specifically, detailed description can be found in FUJIFILM Research Report No. 50 (2005), pp. 60 to 63. In addition, the pitch of the helical structure can also be adjusted by conditions such as temperature, illuminance, and irradiation time in a case of fixing cholesteric alignment state.

As the cholesteric liquid crystal layer, a liquid crystal compound fixed in a cholesteric alignment state is preferable. The cholesteric alignment state may be an alignment state reflecting right-handed circular polarization, may be an alignment state reflecting left-handed circular polarization, or may include both alignment states. The liquid crystal compound is not particularly limited, and various known compounds can be used.

<<Liquid Crystal Composition>>

The cholesteric liquid crystal layer is a layer formed by curing a liquid crystal composition which includes, with respect to the total solid content of the liquid crystal composition, 25% by mass or more of a cholesteric liquid crystal compound having one ethylenic unsaturated group or one cyclic ether group.

The liquid crystal compound used in the present disclosure is not particularly limited as long as the liquid crystal compound is a cholesteric liquid crystal compound having one ethylenic unsaturated group or one cyclic ether group, and a known liquid crystal compound can be used.

For example, the liquid crystal composition for forming the above-described cholesteric liquid crystal layer contains, with respect to the total solid content of the liquid crystal composition, 25% by mass or more of a cholesteric liquid crystal compound having one ethylenic unsaturated group or one cyclic ether group, and furthermore, may contain other components such as a chiral agent, an alignment control agent, a polymerization initiator, and an alignment assistant.

—Cholesteric Liquid Crystal Compound Having One Ethylenic Unsaturated Group or One Cyclic Ether Group—

The above-described liquid crystal composition includes 25% by mass or more of a cholesteric liquid crystal compound (hereinafter, also referred to as a “specific liquid crystal compound”) having one ethylenic unsaturated group or one cyclic ether group.

The ethylenic unsaturated group in the specific liquid crystal compound is not particularly limited, and examples thereof include a (meth)acryloxy group, a (meth)acrylamide group, a vinyl group, a vinyl ester group, and a vinyl ether group.

Among these, from the viewpoint of reactivity, a (meth)acryloxy group, a (meth)acrylamide group, or a vinyl group is preferable, a (meth)acryloxy group or a (meth)acrylamide group is more preferable, and a (meth)acryloxy group is particularly preferable.

The cyclic ether group in the specific liquid crystal compound is not particularly limited, but from the viewpoint of reactivity, an epoxy group or an oxetanyl group is preferable, and an oxetanyl group is particularly preferable.

In addition, from the viewpoint of suppressing change in reflectance and change in tint after molding, the specific liquid crystal compound is preferably a compound having one ethylenic unsaturated group, and it is more preferable that the above-described liquid crystal composition includes, with respect to the total solid content of the liquid crystal composition, 25% by mass of a cholesteric liquid crystal compound having one ethylenic unsaturated group.

The specific liquid crystal compound may be a compound having both ethylenic unsaturated group and cyclic ether group in one molecule. For example, in a case where the specific liquid crystal compound is a compound having both ethylenic unsaturated group and cyclic ether group, either the number of ethylenic unsaturated groups is 1, or the number of cyclic ether groups is 1. In addition, in a case where the number of ethylenic unsaturated groups in the specific liquid crystal compound is 1, for example, the specific liquid crystal compound may be a compound having one ethylenic unsaturated group and one or more cyclic ether groups.

In a case of including the specific liquid crystal compound having one ethylenic unsaturated group, from the viewpoint of suppressing change in reflectance and change in tint after molding, the above-described liquid crystal composition preferably includes a radical polymerization initiator, and more preferably includes a photoradical polymerization initiator.

In a case of including the specific liquid crystal compound having one cyclic ether group, from the viewpoint of suppressing change in reflectance and change in tint after molding, the above-described liquid crystal composition preferably includes a cationic polymerization initiator, and more preferably includes a photocationic polymerization initiator.

In addition, from the viewpoint of suppressing change in reflectance after molding, the specific liquid crystal compound is preferably a compound having only one ethylenic unsaturated group and no cyclic ether group, a compound having only one cyclic ether group and no ethylenic unsaturated group, or a compound having one ethylenic unsaturated group and having one cyclic ether group.

Furthermore, from the viewpoint of suppressing change in reflectance and change in tint after molding, the specific liquid crystal compound is preferably a compound having both ethylenic unsaturated group and cyclic ether group, and more preferably a compound having one ethylenic unsaturated group and one cyclic ether group.

It is sufficient that the specific liquid crystal compound is a compound having a liquid crystal structure, and the specific liquid crystal compound may be a rod-like liquid crystal compound or a discotic liquid crystal compound.

Among these, from the viewpoint of ease of adjusting the pitch of the helical structure in the cholesteric liquid crystal layer, and viewpoint of suppressing change in reflectance and change in tint after molding, the specific liquid crystal compound is preferably a rod-shaped liquid crystal compound.

As the rod-like liquid crystal compound, an azomethine-based compound, an azoxy-based compound, a cyano biphenyl-based compound, a cyanophenyl ester-based compound, a benzoic acid ester-based compound, a cyclohexane carboxylic acid phenyl ester-based compound, a cyanophenyl cyclohexane-based compound, a cyano-substituted phenyl pyrimidine-based compound, an alkoxy-substituted phenyl pyrimidine-based compound, a phenyl dioxane-based compound, a tolane-based compound, or an alkenylcyclohexylbenzonitrile-based compound is preferably used. In addition to the above-described low-molecular weight liquid crystal compounds, a liquid crystalline polymer compound can also be used.

The above-described cholesteric liquid crystal layer is more preferably a layer in which the alignment is fixed by polymerizing a rod-like liquid crystal compound.

As the rod-like liquid crystal compound, a compound having one ethylenic unsaturated group or one cyclic ether group, among compounds described in Makromol. Chem., vol. 190, p. 2255 (1989), Advanced Materials, vol. 5, p. 107 (1993), U.S. Pat. Nos. 4,683,327A, 5,622,648A, 5,770,107A, WO1995/022586A, WO1995/024455A, WO1997/000600A, WO1998/023580A, WO1998/052905A, JP1989-272551A (JP-H01-272551A), JP1994-016616A (JP-H06-016616A), JP1995-110469A (JP-H07-110469A), JP1999-080081A (JP-H11-080081A), JP2001-328973A, and the like, can be used. Furthermore, as the rod-like liquid crystal compound, for example, a compound having one ethylenic unsaturated group or one cyclic ether group, among compounds described in JP1999-513019A (JP-H11-513019A) and JP2007-279688A, can also be preferably used.

As the discotic liquid crystal compound, for example, a compound having one ethylenic unsaturated group or one cyclic ether group, among compounds described in JP2007-108732A and JP2010-244038A, can be preferably used.

Preferred specific examples of the specific liquid crystal compound include compounds shown below, but it is needless to say that the specific liquid crystal compound is not limited thereto.

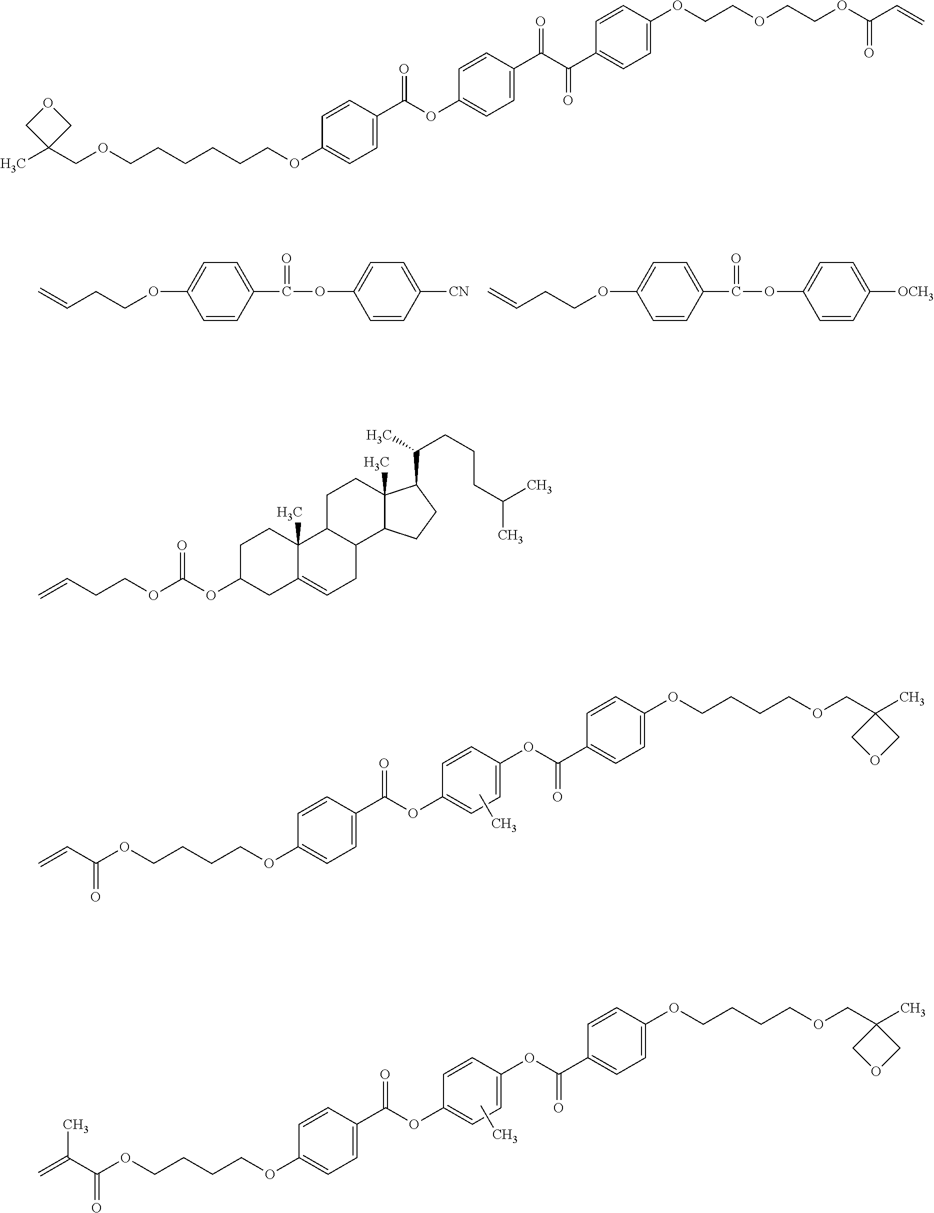

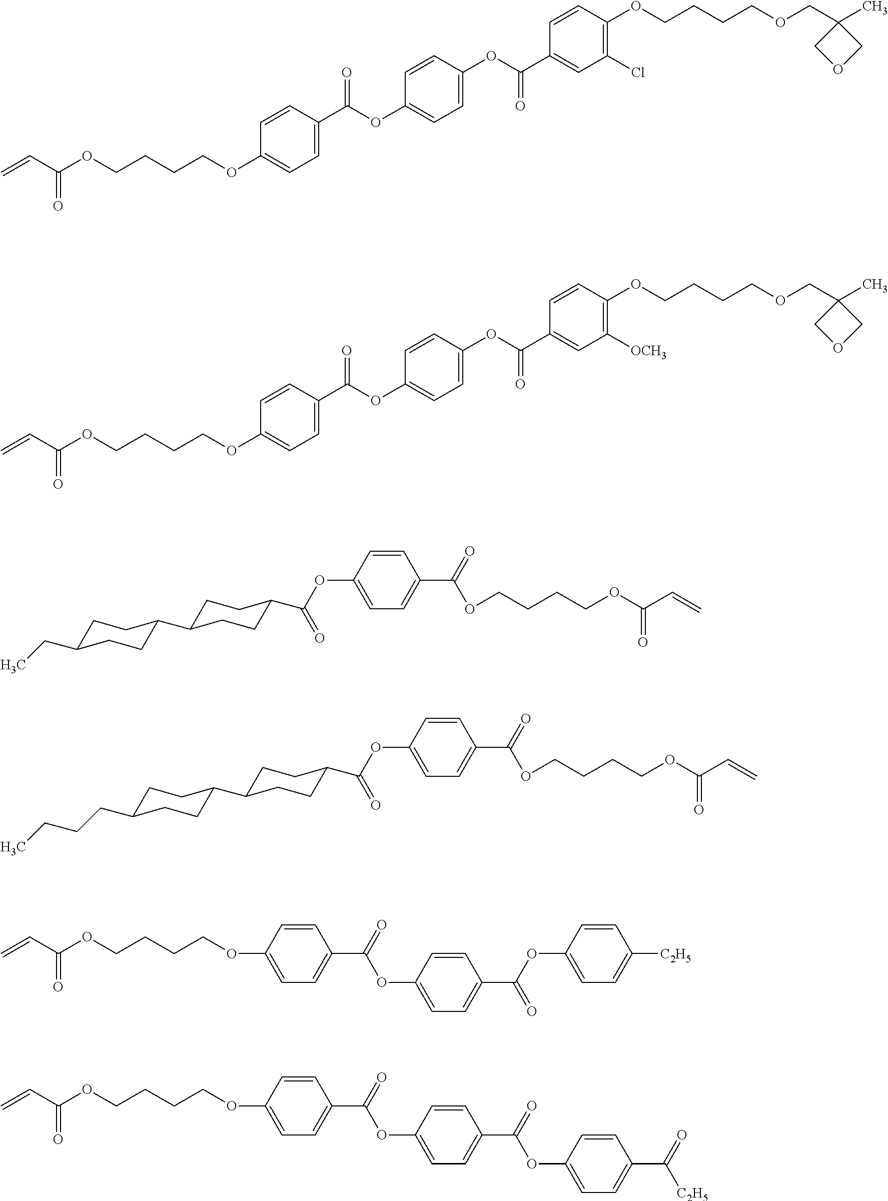

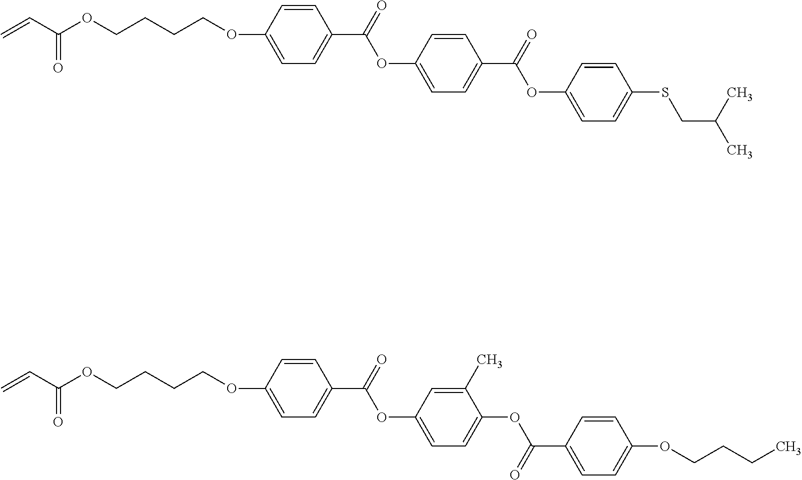

The above-described liquid crystal composition may include one specific liquid crystal compound alone, or may include two or more specific liquid crystal compounds.

The content of the specific liquid crystal compound is 25% by mass or more with respect to the total solid content of the liquid crystal composition. In a case where the content thereof is 25% by mass or more, a decorative film for molding, which has a small change in reflectance after molding, is obtained.

In addition, from the viewpoint of suppressing change in reflectance and change in tint after molding, with respect to the total solid content of the liquid crystal composition, the content of the specific liquid crystal compound is preferably 30% by mass or more, more preferably 40% by mass or more, still more preferably 60% by mass to 99% by mass, and particularly preferably 80% by mass to 98% by mass.

—Other Cholesteric Liquid Crystal Compound—

The above-described liquid crystal composition may include other cholesteric liquid crystal compounds (hereinafter, also simply referred to as “other liquid crystal compounds”) other than the specific liquid crystal compound.

Examples of other liquid crystal compounds include cholesteric liquid crystal compounds having no ethylenic unsaturated group and cyclic ether group, cholesteric liquid crystal compounds having two or more ethylenic unsaturated groups and no cyclic ether group, cholesteric liquid crystal compounds having two or more cyclic ether groups and no ethylenic unsaturated group, and cholesteric liquid crystal compounds having two or more ethylenic unsaturated groups and two or more cyclic ether groups.

Among these, from the viewpoint of suppressing change in reflectance and change in tint after molding, other liquid crystal compounds are preferably at least one compound selected from the group consisting of cholesteric liquid crystal compounds having no ethylenic unsaturated group and cyclic ether group, cholesteric liquid crystal compounds having two or more ethylenic unsaturated groups and no cyclic ether group, or cholesteric liquid crystal compounds having two or more cyclic ether groups and no ethylenic unsaturated group. In addition, other liquid crystal compounds are more preferably at least one compound selected from the group consisting of cholesteric liquid crystal compounds having no ethylenic unsaturated group and cyclic ether group, cholesteric liquid crystal compounds having two ethylenic unsaturated groups and no cyclic ether group, or cholesteric liquid crystal compounds having two cyclic ether groups and no ethylenic unsaturated group. In addition, other liquid crystal compounds are particularly preferably at least one compound selected from the group consisting of cholesteric liquid crystal compounds having no ethylenic unsaturated group and cyclic ether group, or cholesteric liquid crystal compounds having two ethylenic unsaturated groups and no cyclic ether group.

As the other liquid crystal compounds, a known cholesteric liquid crystal compound can be used.

As the polymerizable rod-like liquid crystal compound in the other liquid crystal compounds, compounds described in Makromol. Chem., vol. 190, p. 2255 (1989), Advanced Materials, vol. 5, p. 107 (1993), U.S. Pat. Nos. 4,683,327A, 5,622,648A, 5,770,107A, WO1995/022586A, WO1995/024455A, WO1997/000600A, WO1998/023580A, WO1998/052905A, JP1989-272551A (JP-H01-272551A), JP1994-016616A (JP-H06-016616A), JP1995-110469A (JP-H07-110469A), JP1999-080081A (JP-H11-080081A), JP2001-328973A, and the like can be used. Furthermore, as the rod-like liquid crystal compound, for example, compounds described in JP1999-513019A (JP-H11-513019A) or JP2007-279688A can also be preferably used.

As the discotic liquid crystal compound in the other liquid crystal compounds, for example, compounds described in JP2007-108732A or JP2010-244038A can be preferably used.

The above-described liquid crystal composition may include other liquid crystal compound alone, or may include two or more other liquid crystal compounds.

From the viewpoint of suppressing change in reflectance and change in tint after molding, with respect to the total solid content of the liquid crystal composition, the content of the other liquid crystal compounds is preferably 70% by mass or less, more preferably 60% by mass or less, still more preferably 40% by mass or less, and particularly preferably 5% by mass or less. The lower limit value of the content of the other liquid crystal compounds is 0% by mass.

—Chiral Agent (Optically Active Compound)—

From the viewpoint of ease of forming a cholesteric liquid crystal layer and ease of adjusting the pitch of the helical structure, the above-described liquid crystal composition preferably includes a chiral agent (optically active compound).

The chiral agent has a function of inducing a helical structure in the cholesteric liquid crystal layer.

Since the twist direction or helical pitch of the helix induced by the chiral agent is different depending on the liquid crystal compound, the chiral agent may be selected according to the purpose.

The chiral agent is not particularly limited, and a known compound (for example, a chiral agent for twisted nematic (TN) and super-twisted nematic (STN), described in Liquid Crystal Device Handbook, Chapter 3, Section 4-3, p. 199, Japan Society for the Promotion of Science edited by the 142nd committee, 1989), an isosorbide derivative, or an isomannide derivative can be used.

The chiral agent generally includes an asymmetric carbon atom, but an axially asymmetric compound or a surface asymmetric compound, which does not have the asymmetric carbon atom, can also be used as the chiral agent.

Preferred examples of the axially asymmetric compound or the surface asymmetric compound include a binaphthyl compound, a helicene compound, and a paracyclophane compound.

From the viewpoint of suppressing change in reflectance after molding, the above-described liquid crystal composition preferably includes, as the chiral agent, a chiral agent having a polymerizable group, and more preferably includes, as the chiral agent, a chiral agent having a polymerizable group and a chiral agent not having a polymerizable group.

The polymerizable group is not particularly limited as long as the group is polymerizable, but from the viewpoint of reactivity and viewpoint of suppressing change in reflectance after molding, the polymerizable group is preferably an ethylenic unsaturated group or a cyclic ether group, and more preferably an ethylenic unsaturated group.

Preferred aspects of the ethylenic unsaturated group and cyclic ether group in the chiral agent are the same as the preferred aspects of the ethylenic unsaturated group and cyclic ether group in the above-described specific liquid crystal compound, respectively.

In addition, in a case where the chiral agent has an ethylenic unsaturated group or a cyclic ether group, from the viewpoint of reactivity and viewpoint of suppressing change in reflectance after molding, it is preferable that the ethylenic unsaturated group or cyclic ether group included in the specific liquid crystal compound of the above-described liquid crystal composition has the same type of the ethylenic unsaturated group or cyclic ether group included in the chiral agent (for example, an ethylenic unsaturated group, preferably a (meth)acryloxy group), and it is more preferable to be the same group.

Furthermore, from the viewpoint of reactivity and viewpoint of suppressing change in reflectance after molding, the chiral agent having a polymerizable group is preferably a chiral agent having two or more polymerizable groups, more preferably a chiral agent having two or more ethylenic unsaturated groups or a chiral agent having two or more cyclic ether groups, and particularly preferably a chiral agent having two or more ethylenic unsaturated groups.

In addition, the chiral agent may be a cholesteric liquid crystal compound.

As will be described later, in a case of controlling the size of the helical pitch of the cholesteric liquid crystal layer by irradiating the cholesteric liquid crystal layer with light during manufacturing of the cholesteric liquid crystal layer, it is preferable to include a chiral agent (hereinafter, also referred to as a “photosensitive chiral agent”) capable of changing the helical pitch of the cholesteric liquid crystal layer in response to light.

The photosensitive chiral agent is a compound in which the structure can be changed by absorbing light, thereby being capable of changing the helical pitch of the cholesteric liquid crystal layer. As such a compound, a compound which causes at least one of a photoisomerization reaction, a photodimerization reaction, or a photodegradation reaction is preferable.

The compound which causes a photoisomerization reaction refers to a compound which causes stereoisomerization or structural isomerization by the action of light. Examples of the photoisomerization compound include an azobenzene compound and a spiropyran compound.

In addition, the compound which causes a photodimerization reaction refers to a compound which causes an addition reaction between two groups so as to be cyclized by irradiation with light. Examples of the photodimerizable compound include a cinnamic acid derivative, a coumarin derivative, a chalcone derivative, and a benzophenone derivative.

In addition, the light is not particularly limited, and examples thereof include ultraviolet light, visible light, and infrared light.

Preferred examples of the above-described photosensitive chiral agent include a chiral agent represented by Formula (CH1). The chiral agent represented by Formula (CH1) can change the alignment structure such as the helical pitch (that is, helical cycle and twist cycle) of a cholesteric liquid crystalline phase according to the amount of light during irradiation with light.

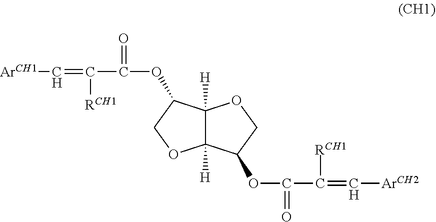

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group.

The aryl group of Ar^{CH1} and Ar^{CH2} in Formula (CH1) may have a substituent, and the aryl group thereof preferably has a total carbon number of 6 to 40, and more preferably has a total carbon number of 6 to 30. As the substituent, for example, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a heterocyclic group is preferable, and a halogen atom, an alkyl group, an alkenyl group, an alkoxy group, a hydroxy group, an acyloxy group, an alkoxycarbonyl group, or an aryloxycarbonyl group is more preferable.

In Formula (CH1), it is preferable that R^{CH1} and R^{CH2} are each independently a hydrogen atom.

Among these, as Ar^{CH1} and Ar^{CH2}, an aryl group represented by Formula (CH2) or Formula (CH3) is preferable.

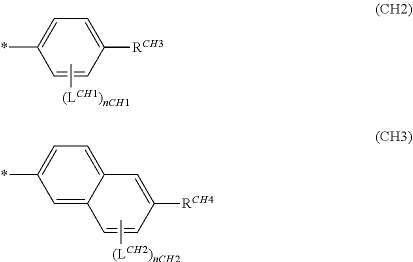

In Formula (CH2) and Formula (CH3), R^{CH3} and R^{CH4} each independently represent a hydrogen atom, a halogen atom, an alkyl group, an alkenyl group, an alkynyl group, an aryl group, a heterocyclic group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with the ethylene unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.

nCH1 in Formula (CH2) is preferably 0 or 1.

nCH2 in Formula (CH3) is preferably 0 or 1.

The heteroaromatic ring group of Ar^{CH1} and Ar^{CH2} in Formula (CH1) may have a substituent, and the heteroaromatic ring group thereof preferably has a total carbon number of 4 to 40, and more preferably has a total carbon number of 4 to 30. As the substituent, for example, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable.

As the heteroaromatic ring group, a pyridyl group, a pyrimidinyl group, a furyl group, or a benzofuranyl group is preferable, and a pyridyl group or a pyrimidinyl group is more preferable.

The above-described liquid crystal composition may include one chiral agent alone, or may include two or more chiral agents.

The content of the chiral agent can be appropriately selected according to the desired pitch of the structure or helical structure of the specific liquid crystal compound to be used. However, from the viewpoint of ease of forming a cholesteric liquid crystal layer and ease of adjusting the pitch of the helical structure, and viewpoint of suppressing change in reflectance after molding, the content of the chiral agent is preferably 1% by mass to 20% by mass, more preferably 2% by mass to 15% by mass, and particularly preferably 3% by mass to 10% by mass with respect to the total solid content of the above-described liquid crystal composition.

In addition, in a case where the liquid crystal composition contains a chiral agent having a polymerizable group as the chiral agent, from the viewpoint of suppressing change in reflectance after molding, the content of the chiral agent having a polymerizable group is preferably 0.2% by mass to 15% by mass, more preferably 0.5% by mass to 10% by mass, still more preferably 1% by mass to 8% by mass, and particularly preferably 1.5% by mass to 5% by mass with respect to the total solid content of the above-described liquid crystal composition.

Furthermore, in a case where the liquid crystal composition contains a chiral agent not having a polymerizable group as the chiral agent, from the viewpoint of suppressing change in reflectance after molding, the content of the chiral agent not having a polymerizable group is preferably 0.2% by mass to 20% by mass, more preferably 0.5% by mass to 15% by mass, and particularly preferably 1.5% by mass to 10% by mass with respect to the total solid content of the above-described liquid crystal composition.

In addition, the pitch of the helical structure of the cholesteric liquid crystal in the cholesteric liquid crystal layer, and the selective reflection wavelength and its range described later can be easily adjusted by changed not only by adjusting the type of the liquid crystal compound used but also by adjusting the content of the chiral agent. Although it cannot be said unconditionally, in a case where the content of the chiral agent in the liquid crystal composition is doubled, the above-described pitch may be halved and the center value of the above-described selective reflection wavelength may be halved.

—Polymerization Initiator—

The liquid crystal composition preferably includes a polymerization initiator, and more preferably includes a photopolymerization initiator.

In addition, in a case where the above-described liquid crystal composition includes the specific liquid crystal compound having one ethylenic unsaturated group, from the viewpoint of suppressing change in reflectance and change in tint after molding, the above-described liquid crystal composition preferably includes a radical polymerization initiator, and more preferably includes a photoradical polymerization initiator.

Furthermore, in a case where the above-described liquid crystal composition includes the specific liquid crystal compound having one cyclic ether group, from the viewpoint of suppressing change in reflectance and change in tint after molding, the above-described liquid crystal composition preferably includes a cationic polymerization initiator, and more preferably includes a photocationic polymerization initiator.

In addition, it is preferable that the above-described liquid crystal composition includes only one of the radical polymerization initiator or the cationic polymerization initiator as the polymerization initiator.

As the polymerization initiator, a known polymerization initiator can be used.

In addition, the polymerization initiator is preferably a photopolymerization initiator capable of initiating a polymerization reaction by ultraviolet irradiation.

Examples of the photopolymerization initiator include α-carbonyl compounds (described in U.S. Pat. Nos. 2,367,661A and 2,367,670A), acyloin ether compounds (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine compounds and phenazine compounds (described in JP1985-105667A (JP-S60-105667A) and U.S. Pat. No. 4,239,850A), and oxadiazole compounds (described in U.S. Pat. No. 4,212,970A).

In addition, as the photoradical polymerization initiator, a known photoradical polymerization initiator can be used.

Preferred examples of the photoradical polymerization initiator include α-hydroxyalkylphenone compounds, α-aminoalkylphenone compounds, and acylphosphine oxide compounds.

Furthermore, as the photocationic polymerization initiator, a known photocationic polymerization initiator can be used.

Preferred examples of the photocationic polymerization initiator include iodonium salt compounds and sulfonium salt compounds.

The above-described liquid crystal composition may include one polymerization initiator alone, or may include two or more polymerization initiators.

The content of the polymerization initiator can be appropriately selected according to a desired pitch of the structure or helical structure of the specific liquid crystal compound to be used. From the viewpoint of ease of forming a cholesteric liquid crystal layer, ease of adjusting the pitch of the helical structure, a polymerization rate, and the strength of the cholesteric liquid crystal layer, the content of the polymerization initiator is preferably 0.05% by mass to 10% by mass, more preferably 0.05% by mass to 5% by mass, still more preferably 0.1% by mass to 2% by mass, and particularly preferably 0.2% by mass to 1% by mass with respect to the total solid content of the above-described liquid crystal composition.

—Crosslinking Agent—

The above-described liquid crystal composition may include a crosslinking agent in order to improve the strength and durability of the cholesteric liquid crystal layer after curing. As the crosslinking agent, a crosslinking agent which cures the liquid crystal composition with ultraviolet rays, heat, humidity, and the like can be suitably used.

The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3-(1-aziridinyl)propionate] and 4,4-bis(ethyleneiminocarbonylamino); isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst can be used depending on reactivity of the crosslinking agent, and in addition to improving the strength and durability of the cholesteric liquid crystal layer, productivity can be improved.

The above-described liquid crystal composition may include one crosslinking agent alone, or may include two or more chiral agents.

From the viewpoint of the strength and durability of the cholesteric liquid crystal layer, the content of the crosslinking agent is preferably 1% by mass to 20% by mass and more preferably 3% by mass to 15% by mass with respect to the total solid content of the above-described liquid crystal composition.

—Polyfunctional Polymerizable Compound—

From the viewpoint of suppressing the change in reflectance after molding, the above-described liquid crystal composition preferably includes a polyfunctional polymerizable compound and more preferably includes a polyfunctional polymerizable compound having the same type of polymerizable group.

Examples of the polyfunctional polymerizable compound include, in the above-described compounds, cholesteric liquid crystal compounds having two or more ethylenic unsaturated groups and no cyclic ether group; cholesteric liquid crystal compounds having two or more cyclic ether groups and no ethylenic unsaturated group; cholesteric liquid crystal compounds having two or more ethylenic unsaturated groups and two or more cyclic ether groups; and the above-described chiral agents and crosslinking agents having two or more polymerizable groups.

Among these, as the polyfunctional polymerizable compound, at least one compound selected from the group consisting of cholesteric liquid crystal compounds two or more ethylenic unsaturated groups and no cyclic ether group, cholesteric liquid crystal compounds having two cyclic ether groups and no ethylenic unsaturated group, and chiral agents having two or more polymerizable groups is preferable, and chiral agents having two or more polymerizable groups are more preferable.

The above-described liquid crystal composition may include one polyfunctional polymerizable compound alone, or may include two or more polyfunctional polymerizable compounds.

From the viewpoint of suppressing change in reflectance after molding, the content of the polyfunctional polymerizable compound is preferably 0.5% by mass to 70% by mass, more preferably 1% by mass to 50% by mass, still more preferably 1.5% by mass to 20% by mass, and particularly preferably 2% by mass to 10% by mass with respect to the total solid content of the above-described liquid crystal composition.

—Other Additives—

The above-described liquid crystal composition may include other additives other than those described above as necessary.

As other additives, a known additive can be used, and examples thereof include a surfactant, a polymerization inhibitor, an antioxidant, a horizontal alignment agent, an ultraviolet absorber, a light stabilizer, a colorant, and metal oxide particles.

In addition, the above-described liquid crystal composition may include a solvent. The solvent is not particularly limited and can be selected according to the purpose, but an organic solvent is preferably used.

The organic solvent is not particularly limited and can be selected according to the purpose, and examples thereof include ketones such as methyl ethyl ketone and methyl isobutyl ketone, alkyl halides, amides, sulfoxides, heterocyclic compounds, hydrocarbons, esters, and ethers. The solvent may be used alone or in combination of two or more kinds thereof. Among these, in consideration of burden on the environment, ketones are particularly preferable. In addition, the above-described component may function as the solvent.

The content of the solvent in the above-described liquid crystal composition is not particularly limited, and may be adjusted to a content of the solvent such that a desired coatability is obtained.

The content of solid contents with respect to the total mass of the above-described liquid crystal composition is not particularly limited, but is preferably 1% by mass to 90% by mass, more preferably 5% by mass to 80% by mass, and particularly preferably 10% by mass to 80% by mass.

The content of the solvent in the liquid crystal composition during curing in a case of forming the above-described cholesteric liquid crystal layer is preferably 5% by mass or less, more preferably 3% by mass or less, still more preferably 2% by mass or less, and particularly preferably 1% by mass or less with respect to the total solid content of the above-described liquid crystal composition.

In addition, the content of the solvent in the cholesteric liquid crystal layer obtained by curing the above-described liquid crystal composition is preferably 5% by mass or less, more preferably 3% by mass or less, still more preferably 2% by mass or less, and particularly preferably 1% by mass or less with respect to the total mass of the above-described cholesteric liquid crystal layer.

—Coating and Curing of Liquid Crystal Composition—

The coating of the above-described liquid crystal composition can be performed by a method of developing a liquid crystal composition in a solution state with the solvent or a liquid crystal composition in a liquid state such as a molten liquid by heating according to an appropriate method such as a roll coating method, a gravure printing method, and a spin coating method. Furthermore, the coating of the polymerizable liquid crystal can be performed according to various methods such as a wire bar coating method, an extrusion coating method, a direct gravure coating method, a reverse gravure coating method, and a die-coating method. In addition, using an inkjet device, the above-described liquid crystal composition can be discharged from a nozzle to form a coating film.

Thereafter, the above-described cholesteric liquid crystal layer is formed by curing the above-described liquid crystal composition. By the curing, the alignment state of molecules of the liquid crystal compound including the above-described specific liquid crystal compound is maintained and fixed. The curing is preferably performed by a polymerization reaction of polymerizable groups such as the ethylenic unsaturated group and the cyclic ether group in the liquid crystal compound.

In a case of using the above-described solvent, after the coating of the above-described liquid crystal composition and before the polymerization reaction for curing, it is preferable that the coating film is dried by a known method. For example, the coating film may be dried by allowing to stand or by heating.

It is sufficient that the liquid crystal compound in the above-described liquid crystal composition is aligned after the coating and drying of the above-described liquid crystal composition.

—Selective Reflectivity of Cholesteric Liquid Crystal Layer—

The above-described cholesteric liquid crystal layer preferably has selective reflectivity in a specific wavelength range.

In the present specification, a selective reflection wavelength refers to an average value of two wavelengths indicating T½ (%): a half-value transmittance expressed by the following expression, in a case where the minimum value of the transmittance of a target object (that is, a member) is defined as Tmin (%). Having selective reflectivity means having a specific wavelength range which satisfies the selective reflection wavelength.

T½=100−(100−Tmin)/2 Expression for calculating half-value transmittance:

The selective reflection wavelength in the above-described cholesteric liquid crystal layer is not particularly limited, and for example, can be set to any range of visible light (380 nm to 780 nm) and near-infrared light (more than 780 nm and 2,000 nm or less).

Among these, it is preferable that the above-described cholesteric liquid crystal layer has selective reflectivity in at least a part of wavelength range of 380 nm to 1,200 nm.

—Layer Configuration of Cholesteric Liquid Crystal Layer—

From the viewpoint of suppressing change in reflectance after molding, the decorative film for molding according to the embodiment of the present disclosure preferably has two or more cholesteric liquid crystal layers.

In addition, each of the two or more cholesteric liquid crystal layers may have the same composition or may be different in composition.

In a case where the decorative film for molding according to the embodiment of the present disclosure has two or more cholesteric liquid crystal layers, it is sufficient that the decorative film for molding according to the embodiment of the present disclosure has at least one layer formed by curing a liquid crystal composition which includes, with respect to the total solid content of the liquid crystal composition, 25% by mass or more of a cholesteric liquid crystal compound having one ethylenic unsaturated group or one cyclic ether group. From the viewpoint of suppressing change in reflectance after molding, it is preferable that all the two or more cholesteric liquid crystal layers are a layer formed by curing a liquid crystal composition which includes, with respect to the total solid content of the liquid crystal composition, 25% by mass or more of a cholesteric liquid crystal compound having one ethylenic unsaturated group or one cyclic ether group.

In addition, for example, in a case where the decorative film for molding according to the embodiment of the present disclosure has two or more cholesteric liquid crystal layers, from the viewpoint of suppressing change in reflectance after molding, it is preferable to have the cholesteric liquid crystal layer on each surface of the above-described base material.

—Thickness of Cholesteric Liquid Crystal Layer—

From the viewpoint of suppressing change in reflectance after molding, the thickness of the above-described cholesteric liquid crystal layer is preferably 0.3 μm to 15 μm, more preferably 0.5 μm to 9 μm, and particularly preferably 0.6 μm to 3 μm. In a case of having two or more cholesteric liquid crystal layers, it is preferable that the cholesteric liquid crystal layers each independently have a thickness within the above-described thickness range.

<Alignment Layer>

The decorative film for molding according to the embodiment of the present disclosure may have an alignment layer which is in contact with the above-described cholesteric liquid crystal layer. The alignment layer is used for aligning the molecules of the liquid crystal compound in the liquid crystal composition in a case of forming a layer including the liquid crystal compound.

The alignment layer is used in a case of forming a layer such as a liquid crystal layer, and the decorative film for molding according to the embodiment of the present disclosure may or may not include the alignment layer.

The alignment layer can be provided by a method of a rubbing treatment of an organic compound (preferably a polymer), an oblique vapor deposition of an inorganic compound such as SiO, a formation of a layer having a microgroove, and the like. Furthermore, an alignment layer in which an alignment function occurs by application of an electric field, application of a magnetic field, or light irradiation has also been known.

Depending on the material of an underlayer such as the base material and the cholesteric liquid crystal layer, the alignment layer may be provided, or the underlayer may be subjected to a direct alignment treatment (for example, rubbing treatment) to function as an alignment layer. Polyethylene terephthalate (PET) can be mentioned as an example of a base material which can be used as such an underlayer.

In addition, in a case where a layer is directly laminated on the cholesteric liquid crystal layer, the cholesteric liquid crystal layer as the underlayer may act as the alignment layer and the liquid crystal compound for forming an upper layer can be aligned. In such a case, the liquid crystal compound in the upper layer can be aligned without providing the alignment layer or performing a special alignment treatment (for example, rubbing treatment).

The thickness of the alignment layer is not particularly limited, but is preferably in a range of 0.01 μm to 10 μm.

Hereinafter, as a preferred example, a rubbing-treated alignment layer which is used by subjecting a surface to a rubbing treatment, and a photo alignment layer will be described.

—Rubbing-Treated Alignment Layer—

Examples of a polymer which can be used in the rubbing-treated alignment layer include a methacrylate-based copolymer, a styrene-based copolymer, polyolefin, polyvinyl alcohol and modified polyvinyl alcohol, poly(N-methylol acrylamide), polyester, polyimide, a vinyl acetate copolymer, carboxymethyl cellulose, and polycarbonate, which are described in paragraph 0022 of JP1996-338913A (JP-H08-338913A). A silane coupling agent can be used as the polymer. Among these, a water-soluble polymer (for example, poly(N-methylol acrylamide), carboxymethyl cellulose, gelatin, polyvinyl alcohol, and modified polyvinyl alcohol) is preferable, gelatin, polyvinyl alcohol, or modified polyvinyl alcohol is more preferable, and polyvinyl alcohol or modified polyvinyl alcohol is particularly preferable.

The molecules of the liquid crystal compound are aligned by coating a rubbing-treated surface of the alignment layer with the above-described liquid crystal composition. Thereafter, as necessary, by reacting the alignment layer polymer with a polyfunctional monomer contained in the cholesteric liquid crystal layer, or by crosslinking the alignment layer polymer using a crosslinking agent, the cholesteric liquid crystal layer can be formed.

—Rubbing Treatment—

The surface of the alignment layer, the base material, or other layers, to be coated with the above-described composition for forming the cholesteric liquid crystal layer, may be subjected to a rubbing treatment as necessary. The rubbing treatment can be generally performed by rubbing a surface of a film containing a polymer as a main component with paper or cloth in a certain direction. The general method of the rubbing treatment is described in, for example, “Handbook of Liquid crystals” (published by Maruzen, Oct. 30, 2000).

As a method of changing a rubbing density, the method described in “Handbook of Liquid crystals” (published by Maruzen) can be used. The rubbing density (L) is quantified by Expression (A).

L=NI(1+2πrn/60v) Expression (A)

In Expression (A), N is the number of times of rubbing, I is a contact length of a rubbing roller, r is a radius of the roller, n is a rotation speed (revolutions per minute: rpm) of the roller, and v is a stage moving speed (speed per second).

In order to increase the rubbing density, it is sufficient that the number of times of rubbing is increased, the contact length of the rubbing roller is increased, the radius of the roller is increased, the rotation speed of the roller is increased, or the stage moving speed is decreased. On the other hand, in order to decrease the rubbing density, it is sufficient that the reverse is carried out. In addition, with regard to conditions of the rubbing treatment, the description in JP4052558B can be referred to.

—Photo Alignment Layer—

A photo alignment material used for the photo alignment layer formed by light irradiation is described in many references. Preferred examples thereof include azo compounds described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadiimide compounds having a photo alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. As the photo alignment material, azo compounds or photo-crosslinkable polyimides, polyamides, or esters are particularly preferable.

The photo alignment layer is produced by subjecting the photo alignment layer formed of the above-described photo alignment material to an irradiation of linearly polarized light or non-polarized light.

In the present specification, the “irradiation of linearly polarized light” is an operation for causing a photo-reaction of the photo alignment material. The wavelength of the light used depends on the photo alignment material used, and is not particularly limited as long as a wavelength necessary for the photo-reaction. The peak wavelength of the light used for light irradiation is preferably 200 nm to 700 nm and the light is more preferably UV light having a peak wavelength of 400 nm or less.

Examples of a light source used for light irradiation include known light sources, for example, lamps such as a tungsten lamp, a halogen lamp, a xenon lamp, a xenon flash lamp, a mercury lamp, a mercury-xenon lamp, and a carbon arc lamp, various lasers (such as semiconductor laser, helium neon laser, argon ion laser, helium cadmium laser, and YAG laser), light emitting diodes, cathode ray tube, and the like.

As a method for obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) or a reflective type polarizer using Brewster's angle, or a method of using light emitted from a polarized laser light source can be adopted. In addition, by using a filter or a wavelength conversion element, only light having a required wavelength may be irradiated selectively.

In a case where the irradiated light is the linearly polarized light, a method of irradiating, from the upper surface or the back surface, the alignment layer with the light perpendicularly or obliquely to the surface of the alignment layer is exemplified. The incidence angle of the light varies depending on the photo alignment material, but is preferably 0° to 90° (perpendicular) and more preferably 40° to 90° with respect to the alignment layer.

In a case of using the non-polarized light, the non-polarized light is irradiated obliquely. The incidence angle of the light is preferably 10° to 80°, more preferably 20° to 60°, and particularly preferably 30° to 50°.

The irradiation time is preferably 1 minute to 60 minutes and more preferably 1 minute to 10 minutes.

<Colored Layer>

From the viewpoint of designability, the decorative film for molding according to the embodiment of the present disclosure preferably further has a colored layer. The above-described colored layer is a layer including a colorant.

The position of the colored layer in the decorative film for molding according to the embodiment of the present disclosure is not particularly limited. The colored layer can be provided at a desired position, and preferred examples thereof include the following two aspects.

In one aspect, from the viewpoint of designability, it is preferable that the decorative film for molding according to the embodiment of the present disclosure further has a colored layer between the base material and the cholesteric liquid crystal layer.

In another aspect, from the viewpoint of designability, moldability, and durability, it is preferable that the decorative film for molding according to the embodiment of the present disclosure further has a colored layer on the cholesteric liquid crystal layer on a side opposite to a side provided with the base material.

In addition, the decorative film for molding according to the embodiment of the present disclosure may have only one colored layer or two or more colored layers.

In the decorative film for molding according to the embodiment of the present disclosure, it is preferable that at least one of the colored layers is a layer for viewing through the above-described cholesteric liquid crystal layer.

By viewing at least one of the colored layers through the above-described cholesteric liquid crystal layer, it is presumed that, based on the anisotropy depending on an angle of incidence ray in the cholesteric liquid crystal layer, the change in color occurs depending on the angle at which the colored layer is viewed, and special designability is exhibited. In addition, the visibility of reflected light is also improved.

In addition, in a case where the decorative film for molding according to the embodiment of the present disclosure has two or more colored layers, preferred examples of an aspect of the two or more colored layers include an aspect in which at least one of the colored layers is a layer for viewing through the above-described cholesteric liquid crystal layer, and at least one other layer of the colored layers is a layer (also referred to as a “color filter layer”) closer to a viewing direction than the above-described cholesteric liquid crystal layer.

The colored layer (color filter layer) closer to a viewing direction than the above-described cholesteric liquid crystal layer is a layer having high transparency to light having at least a specific wavelength. The layer configuration thereof is not particularly limited, and may be a single color filter layer or may be a color filter layer having a color filter structure of two or more colors and having a black matrix or the like as necessary.

By having the above-described color filter layer, it is possible to obtain a decorative film for molding, which has further designability and can view only a specific wavelength range.

In addition, the total light transmittance of the colored layer for viewing through at least one layer of the colored layer, preferably the above-described cholesteric liquid crystal layer, is preferably 10% or less from the viewpoint of visibility.

The color of the colored layer is not limited, and can be appropriately selected depending on the application of the decorative film for molding, and the like. Examples of the color of the colored layer include black, gray, white, red, orange, yellow, green, blue, and violet. In addition, the color of the colored layer may be a metallic color.

In addition, from the viewpoint of designability, it is preferable to have at least one black layer as the colored layer.

From the viewpoint of strength and scratch resistance, the colored layer preferably includes a resin. Examples of the resin include a binder resin described later. In addition, the colored layer may be a layer formed by curing a polymerizable compound, or may be a layer including a polymerizable compound and a polymerization initiator.

The polymerizable compound and polymerization initiator are not particularly limited, and a known compound and initiator can be used.

—Colorant—

Examples of the colorant include a pigment and a dye, and from the viewpoint of durability, a pigment is preferable. In order to make the colored layer metallic, metal particles, pearl pigments, and the like can be applied, and methods such as vapor deposition and plating can also be adopted.

The pigment is not limited, and a known inorganic pigment, organic pigment, and the like can be applied.

Examples of the inorganic pigment include white pigments such as titanium dioxide, zinc oxide, lithopone, light calcium carbonate, white carbon, aluminum oxide, aluminum hydroxide, and barium sulfate; black pigments such as carbon black, titanium black, titanium carbon, iron oxide, and graphite; barium yellow; cadmium red; and chrome yellow.

As the inorganic pigment, inorganic pigments described in paragraph 0015 and paragraph 0114 of JP2005-007765A can also be applied.

Examples of the organic pigment include phthalocyanine-based pigments such as phthalocyanine blue and phthalocyanine green; azo-based pigments such as azo red, azo yellow, and azo orange; quinacridone-based pigments such as quinacridone red, cinquasia red, and cinquasia magenta; perylene pigments such as perylene red and perylene maroon; anthrapyridine; flavanthrone yellow; isoindoline yellow; indanthrone blue; dibromanzathrone red; anthraquinone red; and diketopyrrolopyrrole.

Specific examples of the organic pigment include red pigments such as C. I. Pigment Red 177, 179, 224, 242, 254, 255, and 264; yellow pigments such as C. I. Pigment Yellow 138, 139, 150, 180, and 185; orange pigments such as C. I. Pigment Orange 36, 38, and 71; green pigments such as C. I. Pigment Green 7, 36, and 58; blue pigments such as C. I. Pigment Blue 15:6; and violet pigments such as C. I. Pigment Violet 23.

As the organic pigment, organic pigments described in paragraph 0093 of JP2009-256572A can also be applied.

As the pigment, a pigment (so-called bright pigment) having a light-transmitting property and light-reflecting property may be included. Examples of the bright pigment include metallic bright pigments such as aluminum, copper, zinc, iron, nickel, tin, aluminum oxide, and alloys thereof, interference mica pigments, white mica pigments, graphite pigments, and glass flake pigments. The bright pigment may be uncolored or colored.

In a case where exposure is performed in the molding of the decorative film for molding, the bright pigment is preferably used in a range which does not hinder the curing by exposure.

The colorant may be used alone or in combination of two or more kinds thereof. In addition, in a case where two or more kinds of colorants are used, the inorganic pigment and the organic pigment may be used in combination.

From the viewpoint of a target color development and molding suitability, the content of the colorant in the colored layer is preferably 1% by mass to 50% by mass, more preferably 5% by mass to 50% by mass, and particularly preferably 10% by mass to 40% by mass with respect to the total mass of the colored layer.

—Dispersant—

From the viewpoint of improving dispersibility of the colorant included in the colored layer, particularly the pigment, the colored layer may contain a dispersant. By containing the dispersant, dispersibility of the colorant in the formed colored layer is improved, and the color of the decorative film to be obtained can be uniformized.

The dispersant can be appropriately selected and used according to the type, shape, and the like of the colorant, but is preferably a polymer dispersant.

Examples of the polymer dispersant include silicone polymers, acrylic polymers, and polyester polymers. In a case where it is desired to impart heat resistance to the decorative film, silicone polymers such as a graft type silicone polymer are preferably used as the dispersant.

The weight-average molecular weight of the dispersant is preferably 1,000 to 5,000,000, more preferably 2,000 to 3,000,000, and particularly preferably 2,500 to 3,000,000. In a case where the weight-average molecular weight is 1,000 or more, dispersibility of the colorant is further improved.

As the dispersant, a commercially available product may be used. Examples of the commercially available product include EFKA 4300 (acrylic polymer dispersant) manufactured by BASF Japan; HOMOGENOL L-18, HOMOGENOL L-95, and HOMOGENOL L-100 manufactured by Kao Corporation; Solsperse 20000 and Solsperse 24000 manufactured by Lubrizol Corporation; and DISPERBYK-110, DISPERBYK-164, DISPERBYK-180, and DISPERBYK-182 manufactured by BYK Chemie Japan. Note that, “HOMOGENOL”, “Solsperse”, and “DISPERBYK” are all registered trademarks.

The dispersant may be used alone or in combination of two or more kinds thereof.

The content of the dispersant in the colored layer is preferably 1 part by mass to 30 parts by mass with respect to 100 parts by mass of the colorant.

—Binder Resin—

From the viewpoint of molding suitability, the colored layer preferably contains a binder resin.

The binder resin is not limited, and a known resin can be applied. From the viewpoint of obtaining a desired color, as the binder resin, a transparent resin is preferable, and specifically, a resin having a total light transmittance of 80% or more is preferable. The total light transmittance can be measured by a spectrophotometer (for example, spectrophotometer UV-2100 manufactured by Shimadzu Corporation).

The binder resin is not limited, and a known resin can be applied. Examples of the binder resin include acrylic resins, silicone resins, polyesters, polyurethanes, and polyolefins. The binder resin may be a homopolymer of a specific monomer or a copolymer of the specific monomer and another monomer.

The binder resin may be used alone or in combination of two or more kinds thereof.

From the viewpoint of molding processability, the content of the binder resin in the colored layer is preferably 5% by mass to 70% by mass, more preferably 10% by mass to 60% by mass, and particularly preferably 20% by mass to 60% by mass with respect to the total mass of the colored layer.

—Additive—

The colored layer may contain an additive as necessary, in addition to the above-described components. The additive is not limited, and a known additive can be applied. Examples of the additive include surfactants described in paragraph 0017 of JP4502784B and paragraphs 0060 to 0071 of JP2009-237362A, thermal polymerization inhibitor described in paragraph 0018 of JP4502784B (also referred to as a polymerization inhibitor; preferred examples thereof include phenothiazine), and other additives described in paragraphs 0058 to 0071 of JP2000-310706.

—Method for Forming Colored Layer—

Examples of a method for forming the colored layer include a method of using a composition for forming the colored layer, and a method of attaching colored films to each other. Among the above, as a method for forming the colored layer, a method of using a composition for forming the colored layer is preferable. In addition, the colored layer may be formed by using a commercially available paint such as Nax REAL series, Nax Admila series, and Nax Multi series (manufactured by NIPPONPAINT Co., Ltd.) and RETAN PG series (manufactured by Kansai Paint Co., Ltd.).

Examples of the method of using the composition for forming the colored layer include a method of applying the composition for forming the colored layer to form a colored layer, and a method of printing the composition for forming the colored layer to form a colored layer. Examples of the printing method include screen printing, inkjet printing, flexographic printing, gravure printing, and offset printing.

The composition for forming the colored layer includes a colorant. In addition, the composition for forming the colored layer preferably includes an organic solvent, and may include each of the above-described components which can be contained in the colored layer.

The content of each of the above-described components which can be contained in the composition for forming the colored layer is preferably adjusted within a range of the amount in which, in the descriptions regarding the content of each of the above-described components in the colored layer, the “colored layer” is read as the “composition for forming the colored layer”.

The organic solvent is not limited, and a known organic solvent can be applied. Examples of the organic solvent include ester compounds, ether compounds, ketone compounds, and aromatic hydrocarbon compounds.

The organic solvent may be used alone or in combination of two or more kinds thereof.

The content of the organic solvent in the composition for forming the colored layer is preferably 5% by mass to 90% by mass and more preferably 30% by mass to 70% by mass with respect to the total mass of the composition for forming the colored layer.

Examples of a method of preparing the composition for forming the colored layer include a method of mixing, for example, the organic solvent and components contained in the colored layer, such as the colorant. In addition, in a case where the composition for forming the colored layer includes a pigment as the colorant, from the viewpoint of improving uniform dispersibility and dispersion stability of the pigment, it is preferable to prepare the composition for forming the colored layer by using a pigment dispersion liquid including a pigment and a dispersant.

—Thickness of Colored Layer—

The thickness of the colored layer is not particularly limited, but from the viewpoint of visibility and three-dimensional moldability, is preferably 0.5 μm or more, more preferably 3 μm or more, still more preferably 3 μm to 50 and particularly preferably 3 μm to 20

In a case of having two or more colored layers, it is preferable that the colored layers each independently have a thickness within the above-described thickness range.

<Protective layer>

The decorative film for molding according to the embodiment of the present disclosure preferably has a protective layer.

The protective layer may be a layer having sufficient strength to protect the above-described cholesteric liquid crystal layer and the like, but is preferably a resin having excellent durability against light, heat, humidity, and the like.

In addition, from the viewpoint of visibility and black tightness (that is, suppression of reflected glare by reflected light from the outside, for example, suppression of reflected glare of fluorescent lamp), the protective layer may be a protective layer having antireflection function.

From the viewpoint of durability, the protective layer preferably includes a resin, more preferably includes at least one resin selected from the group consisting of a siloxane resin, a fluororesin, a urethane resin, an acrylic resin, a polyester resin, a melamine resin, and a polyolefin resin, and still more preferably includes at least one resin selected from the group consisting of a siloxane resin, a fluororesin, and a urethane resin.

The fluororesin is not particularly limited, but examples thereof include resins described in paragraphs 0076 to 0106 of JP2009-217258A and paragraphs 0083 to 0127 of JP2007-229999A.

Examples of the fluororesin include a fluorinated alkyl resin in which a hydrogen atom in olefin is replaced by a fluorine atom, and include polytetrafluoroethylene, polychlorotrifluoroethylene, polyvinylidene fluoride, polyvinyl fluoride, perfluoroalkoxy alkane, a copolymer such as perfluoroethylene propene, ethylene tetrafluoroethylene, and a water-dispersed fluororesin dispersion copolymerized with an emulsifier and a component which enhances affinity with water. Specific examples of such a fluororesin include LUMIFLON and Obbligato manufactured by AGC Inc., ZEFFLE and NEOFLON manufactured by DAIKIN INDUSTRIES, LTD., Teflon (registered trademark) manufactured by Dupont, and KYNAR manufactured by ARKEMA.

In addition, for example, a compound having at least one group of polymerizable functional groups or crosslinking functional groups, and containing a fluorine atom may be used, and examples thereof include radically polymerizable monomers such as perfluoroalkyl (meth)acrylate, a vinyl fluoride monomer, and a vinylidene fluoride monomer, and cationically polymerizable monomers such as perfluorooxetane. Specific examples of such a fluorine compound include LINC3A manufactured by KYOEISHA CHEMICAL CO., LTD, OPTOOL manufactured by DAIKIN INDUSTRIES, LTD., OPSTAR manufactured by Arakawa Chemical Industries, Ltd., and tetrafluorooxetane manufactured by DAIKIN INDUSTRIES, LTD.

—Siloxane Compound—

The coating solution for forming the protective layer preferably contains a siloxane compound. A suitable siloxane resin can be obtained by hydrolyzing and condensing the siloxane compound.

In particular, as the siloxane compound, at least one compound (hereinafter, also referred to as a specific siloxane compound) selected from the group consisting of a siloxane compound represented by Formula 1 and a hydrolyzed condensate of the siloxane compound represented Formula 1 is preferable.

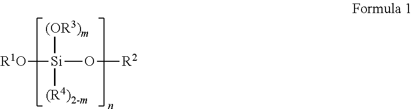

In Formula 1, R′, R², and R³ each independently represent an alkyl group or alkenyl group having 1 to 6 carbon atoms; in a case of a plurality of R⁴'s, the plurality of R⁴'s each independently represent an alkyl group, or an alkyl group having a group selected from the group consisting of a vinyl group, an epoxy group, a vinylphenyl group, a (meth)acryloxy group, a (meth)acrylamide group, an amino group, an isocyanurate group, a ureido group, a mercapto group, a sulfide group, a polyoxyalkyl group, a carboxy group, and a quaternary ammonium group; m represents an integer of 0 to 2; and n represents an integer of 1 to 20.

The hydrolyzed condensate of the siloxane compound represented Formula 1 refers to a compound obtained by condensing the siloxane compound represented Formula 1, and a compound in which at least one part of substituents on the silicon atom in the siloxane compound represented by Formula 1 is hydrolyzed to form a silanol group.

The alkyl group or alkenyl group having 1 to 6 carbon atoms in R′, R², and R³ of Formula 1 may be linear, may have a branch, or may have a ring structure. From the viewpoint of strength, light-transmitting property, and haze of the protective layer, the alkyl group or alkenyl group having 1 to 6 carbon atoms is preferably an alkyl group.

Examples of the alkyl group having 1 to 6 carbon atoms include a methyl group, an ethyl group, a propyl group, an isopropyl group, an n-butyl group, a tert-butyl group, an n-pentyl group, an n-hexyl group, and a cyclohexyl group, and a methyl group or an ethyl group is preferable and a methyl group is more preferable.

From the viewpoint of strength, light-transmitting property, and haze of the protective layer, in a case of a plurality of R⁴'s, the plurality of R⁴'s in Formula 1 are each independently preferably an alkyl group and more preferably an alkyl group having 1 to 8 carbon atoms.

In addition, R⁴ in Formula 1 preferably has 1 to 40 carbon atoms, more preferably has 1 to 20 carbon atoms, and particularly preferably 1 to 8 carbon atoms.

From the viewpoint of strength, light-transmitting property, and haze of the protective layer, m in Formula 1 is preferably 1 or 2 and more preferably 2.

From the viewpoint of strength, light-transmitting property, and haze of the protective layer, n in Formula 1 is preferably an integer of 2 to 20.

Examples of the specific siloxane compound include KBE-04, KBE-13, KBE-22, KBE-1003, KBM-303, KBE-403, KBM-1403, KBE-503, KBM-5103, KBE-903, KBE-9103P, KBE-585, KBE-803, KBE-846, KR-500, KR-515, KR-516, KR-517, KR-518, X-12-1135, X-12-1126, and X-12-1131 manufactured by Shin-Etsu Chemical Co., Ltd.; Dynasylan 4150 manufactured by Evonik Japan; MKC Silicate MS51, MS56, MS57, and MS56S manufactured by Mitsubishi Chemical Corporation.; and Ethyl Silicate 28, N-Propyl Silicate, N-Butyl Silicate, and SS-101 manufactured by Colcoat Co., Ltd.

—Urethane Resin—

The urethane resin which can be suitably used in the present disclosure can be obtained by a reaction of a diisocyanate compound with a polyol, a polymerization reaction of a urethane acrylate compound, or the like.

Examples of the polyol used for synthesizing the polyurethane resin include polyester polyol, polyether polyol, polycarbonate polyol, and polyacrylic polyol. Among these, polyester polyol or polyacrylic polyol is preferable from the viewpoint of impact resistance.

The polyester polyol can be obtained by a known method using an esterification reaction of a polybasic acid and a polyhydric alcohol.

A polycarboxylic acid is used as the polybasic acid component of the polyester polyol, but as necessary, a monobasic fatty acid or the like may be used together. Examples of the polycarboxylic acid include phthalic acid, isophthalic acid, terephthalic acid, tetrahydrophthalic acid, tetrahydroisophthalic acid, hexahydrophthalic acid, hexahydroterephthalic acid, trimellitic acid, pyromellitic acid, other aromatic polycarboxylic acids, adipic acid, sebacic acid, succinic acid, azelaic acid, fumaric acid, maleic acid, itaconic acid, other aliphatic polycarboxylic acids, and anhydrides of these acids. These polybasic acids may be used alone or in combination of two or more kinds thereof.

Examples of the polyhydric alcohol of the polyester polyol and examples of the polyhydric alcohol used in the synthesis of the polyurethane resin include glycols and tri or higher-hydric polyhydric alcohols. Examples of the glycol include ethylene glycol, propylene glycol, diethylene glycol, triethylene glycol, tetraethylene glycol, dipropylene glycol, polyethylene glycol, polypropylene glycol, neopentyl glycol, hexylene glycol, 1,3-butanediol, 1,4-butanediol, 1,5-pentanediol, 1,6-hexanediol, 2-butyl-2-ethyl-1,3-propanediol, methylpropanediol, cyclohexanedimethanol, and 3,3-diethyl-1,5-pentanediol. Examples of the tri or higher-hydric polyhydric alcohol include glycerol, trimethylolethane, trimethylolpropane, pentaerythritol, and dipentaerythritol. These polyhydric alcohols may be used alone or in combination of two or more kinds thereof.

Examples of dimethylol alkanoate include dimethylol propionate, dimethylol butane, dimethylol pentanate, dimethylol heptanate, dimethylol octanate, and dimethylol nonanoate. These dimethylol alkanoates may be used alone or in combination of two or more kinds thereof.

As the polyacrylic polyol, various known polyacrylic polyols having a hydroxy group capable of reacting with an isocyanate group can be used. Examples thereof include polyacrylic polyols in which at least one or more of (meth)acrylic acid, various (meth)acrylic acids with an added hydroxy group, (meth)acrylic acid alkyl esters, (meth)acrylic amides and derivatives thereof, carboxylate esters of vinyl alcohol, unsaturated carboxylic acids, or hydrocarbons having a chain-like unsaturated alkyl moiety is a monomer.

Examples of polyisocyanate compounds include aromatic diisocyanates such as 4,4′-diphenylmethane diisocyanate, 2,4-tolylene diisocyanate, 2,6-tolylene diisocyanate, 1,5-naphthalene diisocyanate, p-phenylene diisocyanate, m-phenylene diisocyanate, xylylene diisocyanate, and m-tetramethylxylylene diisocyanate; alicyclic diisocyanates such as isophorone diisocyanate, 4,4′-dicyclohexylmethane diisocyanate, 1,4-cyclohexylene diisocyanate, and hydrogenated tolylene diisocyanate; and aliphatic diisocyanates such as hexamethylene diisocyanate. Among these, the alicyclic diisocyanate is preferable in terms of resistance to fading and the like. These diisocyanate compounds may be used alone or in combination of two or more kinds thereof.

The urethane (meth)acrylate will be described. Examples of a method for producing the above-described urethane (meth)acrylate include a method in which a compound having a hydroxy group and a (meth)acryloyl group and a polyisocyanate compound are subjected to a urethanization reaction.

Examples of the above-described compound having a hydroxy group and a (meth)acryloyl group include monofunctional (meth)acrylates having a hydroxy group, such as 2-hydroxyethyl (meth)acrylate, 3-hydroxypropyl (meth)acrylate, 4-hydroxy-n-butyl (meth)acrylate, 2-hydroxypropyl (meth) acrylate, 2-hydroxy-n-butyl (meth)acrylate, 3-hydroxy-n-butyl (meth)acrylate, 1,4-cyclohexanedimethanol mono(meth)acrylate, N-(2-hydroxyethyl) (meth)acrylamide, glycerin mono(meth)acrylate, polyethylene glycol mono(meth)acrylate, polypropylene glycol mono(meth)acrylate, 2-hydroxy-3-phenoxypropyl (meth)acrylate, 2-(meth)acryloyloxyethyl-2-hydroxyethylphthalate, and lactone-modified (meth)acrylate having a hydroxy group at the end; and polyfunctional (meth)acrylates having a hydroxy group, such as trimethylolpropane di(meth)acrylate, ethylene oxide (EO)-modified diacrylate of isocyanurate, pentaerythritol tri(meth)acrylate, and dipentaerythritol penta(meth)acrylate. Among these, since scratch resistance of the protective layer is improved, pentaerythritol triacrylate or dipentaerythritol pentaacrylate is preferable. These compounds having a hydroxy group and a (meth)acryloyl group may be used alone or in combination of two or more kinds thereof.

Examples of the above-described polyisocyanate compound include aromatic diisocyanate compounds such as tolylene diisocyanate, diphenylmethane diisocyanate, m-xylylene diisocyanate, and m-phenylenebis(dimethylmethylene) diisocyanate; and aliphatic or alicyclic diisocyanate compounds such as hexamethylene diisocyanate, lysine diisocyanate, 1,3-bis(isocyanatomethyl) cyclohexane, 2-methyl-1,3-diisocyanato cyclohexane, 2-methyl-1,5-diisocyanato cyclohexane, 4,4′-dicyclohexylmethane diisocyanate, and isophorone diisocyanate.

The above-described urethane (meth)acrylate can be cured by irradiating with active light rays. The active light ray refers to ionizing radiation such as ultraviolet rays, electron beams, α rays, β rays, and γ rays. In a case where the protective layer is cured by, after molding, irradiating with ultraviolet rays as the active light ray, it is preferable to add a photopolymerization initiator to the protective layer to improve curability. In addition, as necessary, a photosensitizer can be added thereto to improve the curability.

In the present disclosure, from the viewpoint of protecting the cholesteric liquid crystal layer, it is preferable to have a layer including an ultraviolet (UV) absorber on a viewing side outside the cholesteric liquid crystal layer. The ultraviolet absorber may be included in the protective layer or the base material, and a layer including the ultraviolet absorber (that is, an ultraviolet absorbing layer) may be separately provided.

In the present disclosure, the ultraviolet absorber is a compound having an ultraviolet absorption and having a molecular weight of less than 5,000. In a case where the ultraviolet absorber has a molecular weight distribution, the above-described molecular weight refers to a weight-average molecular weight measured by the above-described method. In a case of not having a molecular weight distribution, the molecular weight is measured using, for example, electrospray ionization mass spectrometry (ESI-MS).

As the ultraviolet absorber, a compound having a maximum absorption wavelength of 380 nm or less is preferable, and a compound having a maximum absorption wavelength of 250 nm to 380 nm (particularly preferably 270 nm to 380 nm) is more preferable.

Examples of the ultraviolet absorber include triazine compounds, benzotriazole compounds, benzophenone compounds, salicylic acid compounds, and metal oxide particles.

From the viewpoint of the ultraviolet absorption, the ultraviolet absorber preferably includes a triazine compound or a benzotriazole compound, and more preferably includes a triazine compound.

The total content of the triazine compound and the benzotriazole compound in the ultraviolet absorber is preferably 80% by mass or more with respect to the total amount of the ultraviolet absorber.

In a case where a layer including the UV absorber is separately provided, the UV absorber is preferably included in a binder polymer. The binder polymer is not particularly limited, but at least one selected from the group consisting of acrylic resin, polyester, polyurethane, polyolefin, siloxane resin, and fluoropolymer is preferable, at least one selected from the group consisting of acrylic resin, polyester, polyurethane, and polyolefin is more preferable, and an acrylic resin is still more preferable.

—Surfactant—

The coating solution for forming the protective layer preferably contains a surfactant. Examples of the surfactant include a nonionic surfactant, an anionic surfactant and a cationic surfactant which are an ionic surfactant, and an amphoteric surfactant, and any of these can be suitably used in the present disclosure.

Among these, from the viewpoint of efficiently forming the core-shell particles due to the attractive force interacting with the above-described specific siloxane compound, storage stability, and light-transmitting property and haze of the protective layer, at least one surfactant selected from the group consisting of a nonionic surfactant and a cationic surfactant is preferable and a cationic surfactant is more preferable.

—Other Components—

In addition to the above-described components, the coating solution for forming the protective layer can contain other components depending on the purpose.

As the other components, a known additive can be used, and examples thereof include an antistatic agent, a condensation catalyst of the siloxane compound, and a preservative.
Antistatic agent

The coating solution for forming the protective layer may contain an antistatic agent. The antistatic agent is used for the purpose of, by imparting antistatic property to the protective layer, suppressing adhesion of contaminants.

The antistatic agent for imparting antistatic property is not particularly limited. As the antistatic agent used in the present disclosure, at least one selected from the group consisting of metal oxide particles, metal nanoparticles, conductive polymers, and ionic liquids can be preferably used. The antistatic agent may be used in combination of two or more kinds thereof.

The metal oxide particles need to be added in a relatively large amount in order to provide antistatic property, and since the metal oxide particles are inorganic particles, antifouling property of the protective layer can be further enhanced by containing the metal oxide particles.

The metal oxide particles are not particularly limited, and examples thereof include tin oxide particles, antimony-doped tin oxide particles, tin-doped indium oxide particles, zinc oxide particles, and silica particles.

Since the metal oxide particles have a large refractive index and, in a case where the particle diameter is large, it is concerned that light-transmitting property may be reduced due to scattering of transmitted light, the average primary particle diameter of the metal oxide particles is preferably 100 nm or less, more preferably 50 nm or less, and particularly preferably 30 nm or less. In addition, the lower limit value is preferably 2 nm or more.

In addition, the shape of the particles is not particularly limited, and may be spherical, plate-shaped, or needle-shaped.

The average primary particle diameter of the metal oxide particles can be determined from a photograph obtained by observing dispersed particles using a transmission electron microscope. A projected area of the particles is obtained from an image of the photograph, and an equivalent circle diameter is obtained therefrom and defined as the average particle diameter (average primary particle diameter). As the average primary particle diameter in the present specification, a value calculated by measuring the projected area of 300 or more particles and calculating the equivalent circle diameter is used.

In a case where the shape of the metal oxide particles is not spherical, the average primary particle diameter may be determined using other methods, for example, dynamic light scattering method.

The coating solution for forming the protective layer may contain only one or two or more kinds of antistatic agents. In a case of containing two or more kinds of metal oxide particles, two or more kinds of metal oxide particles having different average primary particle diameters, shapes, and materials may be used.

In the coating solution for forming the protective layer, the content of the antistatic agent is preferably 40% by mass or less, more preferably 30% by mass or less, and particularly preferably 20% by mass or less with respect to the total solid content of the coating solution for forming the protective layer.

By setting the content of the antistatic agent within the above-described range, the antistatic property can be effectively imparted to the protective layer without lowering film forming property of the coating solution for forming the protective layer.

In addition, in a case of using metal oxide particles as the antistatic agent, the content of the metal oxide particles is preferably 30% by mass or less, more preferably 20% by mass or less, and particularly preferably 10% by mass or less with respect to the total mass of the coating solution for forming the protective layer.

By setting the content of the metal oxide particles within the above-described range, dispersibility of the metal oxide particles in the coating solution for forming the protective layer is good, the occurrence of aggregation is suppressed, and the necessary antistatic property can be imparted to the protective layer.
Condensation catalyst

The coating solution for forming the protective layer preferably contains a condensation catalyst which promotes condensation of the siloxane compound.

In a case where the coating solution for forming the protective layer contains the condensation catalyst, a protective layer having durability can be formed.

The method for forming the protective layer is not particularly limited, and examples thereof include a method of forming the protective layer by applying a coating solution for forming the protective layer on an underlayer of the protective layer and drying the coating solution, and a method of forming a pre-filmed product by laminating or adhering with a pressure sensitive adhesive.

—Preparation of Coating Solution for Forming Protective Layer—

The method for preparing the coating solution for forming the protective layer is not particularly limited, and examples thereof include a method for manufacturing a coating solution for forming the protective layer by mixing an organic solvent, a surfactant, and water, dispersing the organic solvent in the water, adding the specific siloxane compound thereto, and partially hydrolyzing and condensing the mixture to form a shell layer on a surface of the organic solvent and to produce core-shell particles, and a method for manufacturing a coating solution for forming the protective layer by mixing core-shell particles containing an organic solvent as a core material, the specific siloxane compound, a surfactant, and water.

—Formation of Protective Layer—

The above-described coating solution for forming the protective layer is applied onto an underlayer of the protective layer and dried to form the protective layer.

The method of coating the underlayer with the coating solution for forming the protective layer is not particularly limited, and for example, any known coating method such as spray coating, brush coating, roller coating, bar coating, and dip coating can be applied.

In addition, before coating the underlayer with the coating solution for forming the protective layer, the underlayer to be coated with the coating solution for forming the protective layer may be subjected to a surface treatment such as a corona discharge treatment, a glow treatment, an atmospheric plasma treatment, a flame treatment, and an ultraviolet irradiation treatment.

The coating solution for forming the protective layer may be dried at room temperature (for example, 25° C.), or may be heated. From the viewpoint that the organic solvent contained in the coating solution for forming the protective layer is sufficiently volatilized to form voids, from the viewpoint of light-transmitting property and suppression of coloration of the protective layer, and from the viewpoint of, in a case where a resin base material is used as the base material, heating at a temperature below the decomposition temperature of the resin base material, the coating solution for forming the protective layer is preferably heated at 40° C. to 200° C. In addition, from the viewpoint of suppressing thermal deformation of the resin base material, the coating solution for forming the protective layer is more preferably heated at 40° C. to 120° C.

In addition, in a case of heating, the heating time is not particularly limited, but is preferably 1 minute to 30 minutes.

The coating solution for forming the protective layer containing the core-shell particles, and the formation of the protective layer from this coating solution for forming the protective layer have been described above, but the protective layer may be formed using a coating solution for forming the protective layer containing, instead of the core-shell particles, the hollow particles.

Here, from the viewpoint of affinity with the siloxane resin composing the matrix, hollow silica particles having silica as a main component are preferably used as the hollow particles.

Examples of the hollow silica particles include hollow particles described in JP2013-237593A and WO2007/060884A.

In addition, the hollow silica particles may be surface-unmodified hollow silica particles or surface-modified hollow silica particles.

In addition, in order to stabilize dispersion in the coating solution for forming the protective layer, or to improve the affinity and bondability with the siloxane resin, the hollow particles may be subjected to a physical surface treatment such as plasma discharge treatment and corona discharge treatment, or a chemical surface treatment by a surfactant, a coupling agent, and the like.

From the viewpoint of light-transmitting property and scratch resistance, the void volume in the protective layer is preferably 10% to 80%, more preferably 15% to 75%, and particularly preferably 20% to 55%.

From the viewpoint of strength, light-transmitting property, and haze, the diameter (hereinafter, also referred to as a “void diameter”) of voids in the protective layer is preferably 25 nm or more and more preferably 30 nm or more. From the viewpoint of scratch resistance, the upper limit of the void diameter is preferably 80 nm or less and more preferably 70 nm or less.

The method for measuring the void diameter, void volume, and coefficient of variation of the void diameter of the protective layer is as follows.

The decorative film provided with the protective layer is cut in a direction orthogonal to the film surface, and the cut surface is observed with a scanning electron microscope (SEM) to measure the void diameter and the void volume.

In the SEM image (magnification: 50,000 times) of the cut surface, the equivalent circle diameter is calculated for each of 200 voids arbitrarily selected, and the average value thereof is defined as the void diameter.

In addition, in the SEM image (magnification: 50,000 times) of the cut surface, an image processing software (ImageJ) is used to perform image processing (binarization) to separate a void portion and a matrix portion (that is, a portion other than the voids including the siloxane resin), and the proportion of the void portion is calculated to obtain the void volume.

In a case where the diameter of voids has no anisotropy, the void volume is obtained as the volume fraction of the voids in the siloxane resin.

From the viewpoint of visibility and antireflection property, the refractive index of the protective layer in the present disclosure is preferably 1.05 to 1.6, more preferably 1.2 to 1.5, and still more preferably 1.2 to 1.4.

In the present disclosure, the refractive index is a refractive index for light having a wavelength of 550 nm at 25° C.

In addition, in order to make contamination such as wax and gasoline inconspicuous in a case of being used for exteriors of automobiles and the like, it is preferable to set the refractive index in a range close to those refractive indexes, that is, in a range of 1.4 to 1.5.

In addition, in the present disclosure, the thickness and refractive index of each layer are obtained by measuring, for a single film of the protective layer formed on alkali-free glass OA-10G, a transmission spectrum using a spectrophotometer, and performing a fitting analysis using the transmittance obtained in the above measurement and a transmittance calculated by an optical interferometry. In addition, the refractive index can also be measured using a Kalnew precision refractometer (KPR-3000, manufactured by Shimadzu Corporation).

—Thickness of Protective Layer—

The thickness of the protective layer is not particularly limited, but from the viewpoint of wiping resistance and three-dimensional moldability, is preferably 2 μm or more, more preferably 4 μm or more, still more preferably 4 μm to 50 μm, and particularly preferably 4 μm to 20 μm.

<Resin Layer>

In order to secure leveling of the cholesteric liquid crystal layer, the decorative film for molding according to the embodiment of the present disclosure may further has a resin layer between the above-described cholesteric liquid crystal layer and the above-described colored layer.

The resin layer is preferably a layer containing a resin of a type different from that of the protective layer.

From the viewpoint of visibility, the resin layer is preferably a transparent resin layer, and more preferably a layer formed of a transparent film.

The transparent film is not particularly limited as long as a transparent film having a required strength and scratch resistance.

In the present disclosure, the “transparent” in the transparent film means that the total light transmittance of the transparent film is 85% or more. The total light transmittance of the transparent film can be measured by the same method as the total light transmittance of the colored layer described above.

The transparent film is preferably a film formed of a transparent resin, and specific examples thereof include a resin film including a resin such as a polyethylene terephthalate (PET) resin, a polyethylene naphthalate (PEN) resin, an acrylic resin, a polycarbonate (PC) resin, triacetyl cellulose (TAC), and cycloolefin polymer (COP).

In particular, from the viewpoint of shape-following property to the mold, a resin film, including an acrylic resin, a polycarbonate resin, or a polyethylene terephthalate resin in an amount of 60% by mass or more (more preferably 80% by mass or more and still more preferably 100% by mass) with respect to total resin components included in the transparent film, is preferable. In particular, a resin film, including an acrylic resin in an amount of 60% by mass or more (more preferably 80% by mass or more and still more preferably 100% by mass) with respect to total resin components included in the transparent film, is more preferable.

In addition, the thickness of the above-described resin layer is not particularly limited, but is preferably 50 μm to 150

As the transparent film, a commercially available product may be used. Examples of the commercially available product include ACRYPLEN (registered trademark) HBS010 (acrylic resin film, manufactured by Mitsubishi Chemical Corporation.), and TECHNOLLOY (registered trademark) S001G (acrylic resin film, manufactured by Sumitomo Chemical Co., Ltd.), C000 (polycarbonate resin film, manufactured by Sumitomo Chemical Co., Ltd.), and C001 (acrylic resin/polycarbonate resin laminated film, manufactured by Sumitomo Chemical Co., Ltd.).

—Formation of Resin Layer—

The method for forming the resin layer is not particularly limited, and preferred examples thereof include a method of laminating a transparent film on the above-described colored layer.

As a device used in a case of laminating the transparent film, a known laminator such as a laminator, a vacuum laminator, and an auto-cut laminator capable of improving productivity can be used.

It is preferable that the laminator is equipped with any heatable roller such as a rubber roller and can perform pressing and heating.

By heating from the laminator, at least one of the transparent film or the cholesteric liquid crystal layer is partially melted, and it is possible to further enhance adhesiveness between the cholesteric liquid crystal layer and the transparent film.

The temperature at which the transparent film is laminated may be determined according to the material of the transparent film, the melting temperature of the cholesteric liquid crystal layer, and the like, but is a temperature that the temperature of the transparent film can be preferably 60° C. to 150° C., more preferably 65° C. to 130° C., and particularly preferably 70° C. to 100° C.

In addition, in a case of laminating the transparent film, a linear pressure between the transparent film and the cholesteric liquid crystal layer is preferably 60 N/cm to 200 N/cm, more preferably 70 N/cm to 160 N/cm, and particularly preferably 80 N/cm to 120 N/cm.

<Pressure sensitive adhesive layer>

From the viewpoint of easy attachment to other members (preferably, other molding members) and improvement of adhesiveness between layers, the decorative film for molding according to the embodiment of the present disclosure may have a pressure sensitive adhesive layer.

The material of the pressure sensitive adhesive layer is not particularly limited and can be suitably selected depending on the purpose.

Examples thereof include a layer containing a known pressure sensitive adhesive or adhesive.

—Pressure Sensitive Adhesive—

Examples of the pressure sensitive adhesive include an acrylic pressure sensitive adhesive, a rubber-based pressure sensitive adhesive, and a silicone-based pressure sensitive adhesive. In addition, examples of the pressure sensitive adhesive include acrylic pressure sensitive adhesives, ultraviolet (UV) curable pressure sensitive adhesives, and silicone-based pressure sensitive adhesives described in Chapters 2 of “Characterization evaluation of release paper, release film, and adhesive tape, and control technique thereof”, 2004, Information Mechanism. The acrylic pressure sensitive adhesive refers to a pressure sensitive adhesive including a polymer ((meth)acrylic polymer) of a (meth)acrylic monomer.

In a case of containing a pressure sensitive adhesive, the layer may further contain a viscosity imparting agent.

—Adhesive—

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

—Method for Forming Pressure Sensitive Adhesive Layer—

The method for forming the pressure sensitive adhesive layer is not particularly limited, and examples thereof include a method of laminating a protective film on which the pressure sensitive adhesive layer is formed, such that the pressure sensitive adhesive layer and the colored layer are in contact with each other, a method of laminating the pressure sensitive adhesive layer alone so as to contact with the colored layer, and a method of coating the colored layer with a composition including the above-described pressure sensitive adhesive or adhesive. Preferred examples of the laminating method or coating method include the same method as the above-described method of laminating the transparent film or the above-described coating method of the composition for forming the colored layer.

From the viewpoint of achieving both pressure sensitive adhesive force and handleability, the thickness of the pressure sensitive adhesive layer in the decorative film is preferably 5 μm to 100 μm.

<Other layers>

The decorative film for molding according to the embodiment of the present disclosure may have other layers in addition to the above-described layers.

Examples of the other layers include a reflective layer, an ultraviolet absorbing layer, a self-repairing layer, an antistatic layer, an antifouling layer, an anti-electromagnetic wave layer, and a conductive layer, which are known as a layer for a decorative film.

The other layers in the decorative film for molding according to the embodiment of the present disclosure can be formed by known methods. Examples thereof include a method of applying a composition (composition for forming a layer) containing components included in these layers in a layered shape, and drying the composition.

—Cover Film—

For the purpose of preventing stains, and the like, the decorative film for molding according to the embodiment of the present disclosure may have a cover film as an outermost layer.

The cover film is not particularly limited as long as the cover film is formed of a material having flexibility and good peelability, and examples thereof include resin films such as a polyethylene film.

The method for attaching the cover film is not particularly limited, and specific examples thereof include a known attaching method, such as a method of laminating the cover film on the protective layer.

<Preferred Layer Configuration of Decorative Film for Molding>

The layer configuration of the decorative film for molding according to the embodiment of the present disclosure is not particularly limited as long as the decorative film has the base material and the cholesteric liquid crystal layer, but preferred examples thereof include layer configurations described below. In each of the following layer configurations, it is preferable to be an aspect in which the outermost layer is viewed from the side of the layer described on the right side.

Layer configuration 1: cholesteric liquid crystal layer/base material Layer configuration 2: base material/cholesteric liquid crystal layer Layer configuration 3: base material/cholesteric liquid crystal layer/protective layer Layer configuration 4: base material/colored layer/cholesteric liquid crystal layer Layer configuration 5: colored layer/cholesteric liquid crystal layer/base material Layer configuration 6: base material/colored layer/cholesteric liquid crystal layer/protective layer

Layer configuration 7: colored layer/cholesteric liquid crystal layer/base material/protective layer

Layer configuration 8: colored layer/base material/cholesteric liquid crystal layer/colored layer (color filter layer)/protective layer

Layer configuration 9: colored layer/cholesteric liquid crystal layer/base material/cholesteric liquid crystal layer/protective layer

Layer configuration 10: colored layer/cholesteric liquid crystal layer/base material/colored layer (color filter layer)/protective layer

Layer configuration 11: colored layer/cholesteric liquid crystal layer/base material/cholesteric liquid crystal layer/colored layer (color filter layer)/protective layer

Among these, from the viewpoint of durability, and viewpoint of suppressing change in reflectance and change in tint after molding, as the layer configuration in the decorative film for molding according to the embodiment of the present disclosure, the aspect of layer configuration 4 to layer configuration 11 is preferable, the aspect of layer configuration 5 or layer configuration 7 to layer configuration 11 is more preferable, the aspect of layer configuration 7 to layer configuration 11 is still more preferable, the aspect of layer configuration 10 or layer configuration 11 is particularly preferable, and the aspect of layer configuration 11 is most preferable.

In addition, as necessary, it is preferable to have the alignment layer on at least one of the top and bottom of the cholesteric liquid crystal layer in each of the above-described layer configurations.

Furthermore, from the viewpoint of attachment to other members, in each of the layer configurations, it is preferable to further have, as the outermost layer, the pressure sensitive adhesive layer on the side of the layer described on the left side.

Furthermore, from the viewpoint of light resistance, it is preferable to further have the ultraviolet absorbing layer on the side in the viewed direction with respect to the cured liquid crystal layer.

(Method for Manufacturing Decorative Film for Molding)

The method for manufacturing a decorative film for molding according to the embodiment of the present disclosure includes a step of preparing a liquid crystal composition which includes, with respect to a total solid content of the liquid crystal composition, 25% by mass or more of a cholesteric liquid crystal compound having one ethylenic unsaturated group or one cyclic ether group; a step of applying the liquid crystal composition to a base material to form a liquid crystal composition layer; and a step of curing the liquid crystal composition layer to form a cholesteric liquid crystal layer.

<Step of Preparing Liquid Crystal Composition>

The method for manufacturing a decorative film for molding according to the embodiment of the present disclosure preferably includes a step of preparing a liquid crystal composition which includes, with respect to a total solid content of the liquid crystal composition, 25% by mass or more of a cholesteric liquid crystal compound having one ethylenic unsaturated group or one cyclic ether group.

Composition of each component of the liquid crystal composition in the step of preparing a liquid crystal composition is the same as that of the liquid crystal composition in the above-described decorative film for molding, except for aspects described later.

<Step of Forming Liquid Crystal Composition Layer>

The method for manufacturing a decorative film for molding according to the embodiment of the present disclosure preferably includes a step of applying the liquid crystal composition to a base material to form a liquid crystal composition layer.

As the base material used in the step of forming a liquid crystal composition layer, the above-described base material can be suitably used.

As described above, the application of the above-described liquid crystal composition can be performed by a method of developing the polymerizable liquid crystal composition in a solution state with the solvent or in a liquid state, such as a molten liquid by heating, according to an appropriate method such as a roll coating method, a gravure printing method, and a spin coating method. Furthermore, the application of the above-described liquid crystal composition can be performed according to various methods such as a wire bar coating method, an extrusion coating method, a direct gravure coating method, a reverse gravure coating method, and a die-coating method. In addition, using an inkjet device, the above-described liquid crystal composition can be discharged from a nozzle to form a liquid crystal composition layer.

In a case of using the above-described solvent, after the application of the above-described liquid crystal composition and before the step of forming a cholesteric liquid crystal layer, it is preferable that the liquid crystal composition layer is dried by a known method. For example, the liquid crystal composition layer may be dried by allowing to stand or air-drying, or may be dried by heating.

The amount of the above-described liquid crystal composition to be applied may be appropriately set in consideration of the liquid crystal composition layer after drying.

In addition, it is preferable that the liquid crystal compound in the above-described liquid crystal composition are aligned after the application and drying of the above-described liquid crystal composition.

<Step of Forming Cholesteric Liquid Crystal Layer>

The method for manufacturing a decorative film for molding according to the embodiment of the present disclosure preferably includes a step of curing the liquid crystal composition layer to form a cholesteric liquid crystal layer.

In the step of forming a cholesteric liquid crystal layer, the cholesteric liquid crystal layer is formed by curing the above-described liquid crystal composition layer. By the curing, the alignment state of molecules of the liquid crystal compound including the above-described specific liquid crystal compound is maintained and fixed, thereby forming the cholesteric liquid crystal layer.

In addition, the curing is preferably performed by a polymerization reaction of polymerizable groups such as the ethylenic unsaturated group and the cyclic ether group in a compound included in the above-described liquid crystal compound.

Furthermore, the curing is preferably performed by exposure. In a case where the curing is performed by exposure, it is preferable that the above-described liquid crystal composition layer includes a photopolymerization initiator.

A light source for exposure can be appropriately selected and used according to the type of the photopolymerization initiator. Preferred examples thereof include a light source capable of irradiating light in a wavelength range (for example, 365 nm or 405 nm). Specific examples thereof include an ultra-high pressure mercury lamp, a high pressure mercury lamp, and a metal halide lamp.

The exposure amount is not particularly limited and may be set appropriately, but is preferably 5 mJ/cm² to 2,000 mJ/cm² and more preferably 10 mJ/cm² to 1,000 mJ/cm².

In addition, it is preferable to heat the liquid crystal compound in order to facilitate the arrangement of the liquid crystal compound during the curing by the above-described exposure. The heating temperature is not particularly limited and may be selected according to composition of the liquid crystal compound and liquid crystal composition to be used, and examples thereof include 60° C. to 120° C.

In addition, not only the cholesteric liquid crystal layer is formed by the exposure, but also other layers such as the colored layer may also be cured by the exposure as necessary.

In addition, as the exposure method, for example, methods described in paragraphs 0035 to 0051 of JP2006-023696A can be suitably used in the present disclosure.

In addition, in a case where the above-described liquid crystal composition layer is cured by heat, the heating temperature and heating time are not particularly limited, and may be appropriately selected depending on the type of a thermal polymerization initiator and the like to be used. For example, the heating temperature is preferably 60° C. to 200° C., and the heating time is preferably 5 minutes to 2 hours. The heating unit is not particularly limited, and a known heating unit can be used. Examples of the heating unit include a heater, an oven, a hot plate, an infrared lamp, and an infrared laser.

<Other Steps>

The method for manufacturing a decorative film for molding according to the embodiment of the present disclosure may include any other steps, for example, a step of forming a colored layer, a step of forming an alignment layer, a step of forming a protective layer, a step of forming a pressure sensitive adhesive layer, and the like, in addition to the above-described steps as desired.

The formation of each of the above-described layers such as a colored layer can be performed by using the above-described method or a known method.

(Molding method and molded product)

The molding method according to the embodiment of the present disclosure is a molding method using the decorative film for molding according to the embodiment of the present disclosure, and is preferably a molding method including a step of molding the decorative film for molding according to the embodiment of the present disclosure.

In addition, the molded product according to the embodiment of the present disclosure is a molded product obtained by molding the decorative film for molding according to the embodiment of the present disclosure, and is preferably a molded product manufactured by the molding method according to the embodiment of the present disclosure.

<Molding Step>

The molding method according to the embodiment of the present disclosure preferably includes a step of molding the decorative film for molding according to the embodiment of the present disclosure.

Since the decorative film for molding according to the embodiment of the present disclosure has excellent moldability, the decorative film for molding according to the embodiment of the present disclosure can be suitably used for manufacturing a molded product. For example, the decorative film for molding according to the embodiment of the present disclosure is particularly suitable for manufacturing a molded product by at least one molding selected from the group consisting of three-dimensional molding and insert molding.

Hereinafter, the method for producing (method for molding) a molded product will be described in detail by taking insert molding as an example.

In the insert molding, the molded product is obtained, for example, by previously disposing a decorative film for molding in a mold and injection-molding a base material resin into the mold. By this insert molding, a molded product in which the surface of the resin molded product is integrated with the decorative film for molding is obtained.

Hereinafter, one embodiment of the method for producing a molded product by insert molding will be described.

The method for producing a molded product includes a step of disposing a decorative film for molding in a mold for injection molding and closing the mold, a step of injecting a molten resin into the mold, and a step of taking out a molded product in a case where the injected resin has solidified.

The mold for injection molding (that is, molding mold) used for manufacturing the molded product includes a mold (that is, male mold) having a convex shape, and a mold (that is, female mold) having a concave shape corresponding with the convex shape, and after disposing the decorative film for molding on a molding surface which is an inner peripheral surface of the female mold, the mold is closed.

Here, before disposing the decorative film for molding in the molding mold, by molding (preforming) the decorative film for molding using the molding mold, it is also possible to apply a three-dimensional shape to the decorative film for molding in advance and supply the decorative film for molding to the molding mold.

In addition, in a case of disposing the decorative film for molding in the molding mold, it is necessary to align the decorative film for molding with the molding mold in a state of inserting the decorative film for molding into the molding mold.

As a method of aligning the decorative film for molding with the molding mold in a state of inserting the decorative film for molding into the molding mold, there is a method of inserting and holding a fixing pin of the male mold into an alignment hole of the female mold.

Here, in the female mold, the alignment hole is formed in advance at an end portion (specifically, position where the three-dimensional shape is not formed after molding) of the decorative film for molding.

In addition, in the male mold, the fixing pin is formed in advance at a position to be fitted with the alignment hole.

In addition, as a method of aligning the decorative film for molding with the molding mold in a state of inserting the decorative film for molding into the molding mold, the following method can be used in addition to the method of inserting the fixing pin into the alignment hole.

Examples thereof include a method of fine-adjusting and aligning the decorative film for molding by driving on a transporting device side as a target to an alignment mark which is applied in advance to a position of the decorative film for molding where the three-dimensional shape is not formed after molding. In this method, the alignment mark is preferably recognized at two or more diagonal points in a case of viewing from a product portion of the injection-molded product (decorative molded article).

After aligning the decorative film for molding with the molding mold and closing the molding mold, a molten resin is injected into the molding mold in which the decorative film for molding has been inserted. In a case of injection, the molten resin is injected on a side of the above-described resin base material of the decorative film for molding.

The temperature of the molten resin injected into the molding mold is set depending on the physical properties of the used resin, and the like. For example, in a case where the used resin is an acrylic resin, the temperature of the molten resin is preferably in a range of 240° C. to 260° C.

For the purpose of suppressing abnormal deformation of the decorative film for molding due to heat and/or gas generated in a case of injecting the molten resin into the molding mold, a position of an inlet (injection port) of the male mold may be set according to the shape of the molding mold and/or the type of the molten resin.

After solidifying the molten resin which is injected into the molding mold into which the decorative film for molding has been inserted, the molding mold is opened, and an intermediate molded product, in which the decorative film for molding is fixed to a molding base material which is a solidified molten resin, is taken out from the molding mold.

In the intermediate molded product, around a decorative part which will be the final product (molded product), a burr and a dummy portion of the molded product are integrated. Here, the dummy portion has an insertion hole formed by inserting the fixing pin in the above-described alignment.

Therefore, finishing is performed to remove the burr and the dummy portion from the intermediate molded product before the finishing, thereby obtaining a molded product.

In addition, suitable examples of the above-described molding include three-dimensional molding.

Suitable examples of the three-dimensional molding include heat molding, vacuum molding, pressure molding, and vacuum pressure molding.

The method of performing the vacuum molding is not particularly limited, but is preferably a method of performing three-dimensional molding in a heated state under vacuum.

The vacuum means a state in which an inside of a chamber is evacuated to a vacuum degree of 100 Pa or less.

It is sufficient that the temperature in a case of performing the three-dimensional molding is appropriately set depending on the used base material for molding, but the temperature is preferably in a temperature range of 60° C. or higher, more preferably in a temperature range of 80° C. or higher, and still more preferably in a temperature range of 100° C. or higher. The upper limit of the temperature in a case of performing the three-dimensional molding is preferably 200° C.

The temperature in a case of performing the three-dimensional molding means a temperature of the base material for molding supplied for the three-dimensional molding, and is measured by attaching a thermocouple to the surface of the base material for molding.

The above-described vacuum molding can be performed using a vacuum molding technique widely known in the molding field, and for example, the vacuum molding may be performed using Formech 508FS manufactured by NIHON SEIZUKI KOGYO CO., LTD.

<Step of Curing Protective Layer>

In a case where the decorative film for molding has the above-described protective layer, the molding method according to the embodiment of the present disclosure preferably includes a step of curing the protective layer in the molded decorative film for molding.

The curing method in the step of curing the protective layer is not particularly limited, and may be selected according to the crosslinkable group of the above-described siloxane resin included in the protective layer, the presence or absence of the ethylenic unsaturated group of the above-described organic resin, and the above-described polymerization initiator. As the curing method, a method of curing the protective layer with light or heat is preferable, and a method of curing the protective layer with light is more preferable.

If possible, the exposure in the step of curing the protective layer may be performed from either side of the above-described decorative film for molding, but it is preferable to be performed from the side of the protective layer.

In addition, in a case where a cover film is provided as the outermost layer on the side of the protective layer, the exposure may be performed with a state in which the cover film is provided (that is, a state before peeling off the cover film). In a case of performing the exposure from the above-described cover film side, the total light transmittance of the above-described cover film is preferably 80% or more and more preferably 90% or more.

As the exposure method, for example, methods described in paragraphs 0035 to 0051 of JP2006-023696A can be also suitably used in the present disclosure.

As a light source for the exposure, any light source capable of irradiating light in a wavelength range in which the protective layer can be cured (for example, 365 nm or 405 nm) can be appropriately selected and used.

Specific examples thereof include an ultra-high pressure mercury lamp, a high pressure mercury lamp, and a metal halide lamp.

The exposure amount is not particularly limited and may be set appropriately, but is preferably 5 mJ/cm² to 2,000 mJ/cm² and more preferably 10 mJ/cm² to 1,000 mJ/cm².

In addition, in the step of curing the protective layer, in addition to the protective layer, the above-described colored layer may be cured simultaneously or sequentially as necessary.

In a case of exposing the above-described colored layer with light, the above-described colored layer preferably includes the polymerizable compound and the photopolymerization initiator. By exposing the colored layer including the polymerizable compound and the photopolymerization initiator, a cured colored layer can be obtained.

In the step of curing the protective layer, in a case where the protective layer is cured by heat, the heating temperature and heating time are not particularly limited, and may be appropriately selected depending on a thermal polymerization initiator and the like to be used. For example, the heating temperature is preferably 60° C. to 200° C., and the heating time is preferably 5 minutes to 2 hours. The heating unit is not particularly limited, and a known heating unit can be used. Examples thereof include a heater, an oven, a hot plate, an infrared lamp, and an infrared laser.

<Other Steps>

The molding method according to the embodiment of the present disclosure may include any other steps, for example, a step of attaching the decorative film for molding according to the embodiment of the present disclosure to a member for molding, and as described above, a step of removing a burr from the molded product, a step of removing a dummy portion from the molded product, and the like, in addition to the above-described steps as desired.

The other steps are particularly limited, and can be performed by using a known unit and a known method.

The application of the molded product obtained as described above is not particularly limited and can be used for various products, and particularly suitable examples thereof include interior and exterior of automobiles, interior and exterior of electric appliances, and packaging containers. Among these, the interior and exterior of automobiles are preferable, and the exterior of automobiles is more preferable.

### EXAMPLES

Hereinafter, the present disclosure will be described in detail with reference to examples, but the present disclosure is not limited thereto. In the present examples, “%” and “part” respectively indicate “% by mass” and “part by mass” unless otherwise specified.

<Formation of Alignment Layer 1>

As a base material, a polycarbonate/acrylic laminated film (manufactured by Sumika Acryl Co., Ltd., TECHNOLLOY C003) having a thickness of 125 μm was prepared. A coating solution for forming an alignment layer 1 was applied to an acrylic surface of the base material with a wire bar coater.

Thereafter, the base material was dried at 100° C. for 120 seconds to produce a base material having an alignment layer 1 having a layer thickness of 1.5

[Composition of Coating Solution for Forming Alignment Layer 1]
Modified polyvinyl alcohol shown below: 28 parts by mass
Citric acid ester (AS3, manufactured by SANKYO CHEMICAL Co., Ltd.): 1.2 parts by mass
Photopolymerization initiator (IRGACURE 2959, manufactured by BASF): 0.84 parts by mass
Glutaraldehyde: 2.8 parts by mass
Water: 699 parts by mass
Methanol: 226 parts by mass
Modified polyvinyl alcohol (the following compounds; the numbers at the lower right of each constitutional unit represent the molar ratio)

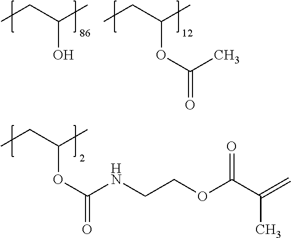

<Formation of Cholesteric Liquid Crystal Layer 1>

The produced alignment film 1 of the base material was subjected to a rubbing treatment (rayon cloth, pressure: 0.1 kgf (0.98 N), rotation speed: 1,000 rpm, transporting speed: 10 m/min, number of times: 1 round trip) in a direction rotated counterclockwise by 31.5° with respect to a short side direction.

Components in the composition shown below were stirred and dissolved in a container kept at 25° C. to prepare a coating solution 1 (liquid crystal composition 1) for a cholesteric liquid crystal layer.

[Composition of Coating Solution 1 for Cholesteric Liquid Crystal Layer]

Methyl ethyl ketone: 150.6 parts

Liquid crystal compound 1 (rod-like liquid crystal compound): 92 parts

Photopolymerization initiator A (IRGACURE 907, manufactured by BASF): 0.50 parts

Chiral agent A: 4.00 parts

Chiral agent B: 4.00 parts

Surfactant F1 described below: 0.027 parts

Liquid crystal compound 1 (monofunctional): rod-like liquid crystal compound shown below; in a case of a radical polymerization type, the liquid crystal compound 1 is defined as monofunctional because, although the liquid crystal compound 1 has an oxetanyl group (cationically polymerizable functional group), the liquid crystal compound 1 has only one acryloxy group (radical polymerizable group); the same applies to the cationic polymerization type.

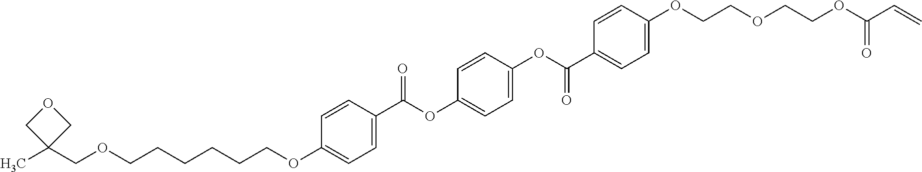 [SMILES: C=CC(=O)OCCOCCOc1ccc(C(=O)Oc2ccc(OC(=O)c3ccc(OCCCCCCOCC4(C)COC4)cc3)cc2)cc1]

Chiral agent A (bifunctional): compound shown below

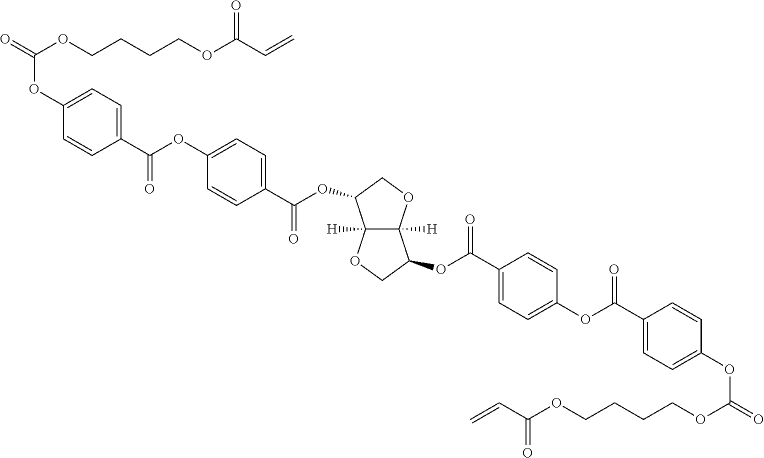 [SMILES: C=CC(=O)OCCCCOC(=O)Oc1ccc(C(=O)Oc2ccc(C(=O)O[C@H]3CO[C@@H]4[C@H]3OC[C@H]4OC(=O)c3ccc(OC(=O)c4ccc(OC(=O)OCCCCOC(=O)C=C)cc4)cc3)cc2)cc1]

Chiral agent B (non-functional): compound shown below; in the following compound, Bu represents an n-butyl group.

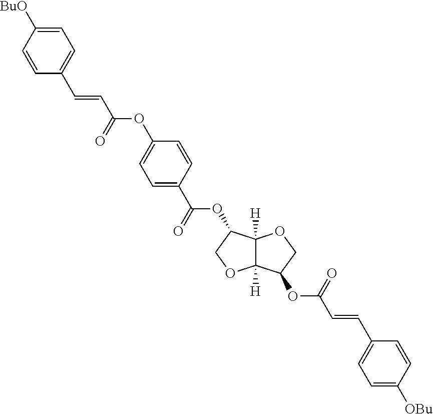

Surfactant F1: compound shown below

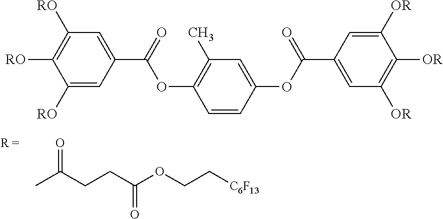

The prepared coating solution 1 for a cholesteric liquid crystal layer was applied to a surface of the rubbing-treated alignment layer 1 with a wire bar coater, and dried at 85° C. for 120 seconds to produce a laminate which had a cholesteric liquid crystal layer 1 having a layer thickness of 1.4

<Formation of Colored Layer 1>

A black paint (Nax REAL 480 manufactured by NIPPONPAINT Co., Ltd.) was applied to the formed cholesteric liquid crystal layer, and dried at 100° C. for 10 minutes to form a colored layer 1 (black colored layer) having a layer thickness of 10

<Formation of Protective Layer 1>

—Synthesis of Acrylate-Modified Acrylic Resin A—

75 g of methyl methacrylate and 88 g of glycidyl methacrylate were copolymerized with each other using a radical polymerization initiator V-601 (2,2′-azobis(isobutyric acid) dimethyl, manufactured by FUJIFILM Wako Pure Chemical Corporation). 50 g of the obtained polymer was reacted with 19.2 g of acrylic acid in the presence of tetraethylammonium chloride to obtain an acrylate-modified acrylic resin A. The weight-average molecular weight thereof was 20,000. The acrylate functional amount (amount of a constitutional unit having an acryloxy group formed by reacting acrylic acid with a constitutional unit derived from glycidyl methacrylate with respect to all resins) was 30% by mass.

—Preparation of Coating Solution 1 for Forming Protective Layer—

The following materials were stirred and mixed at 25° C. for 24 hours to obtain a hydrolyzate 1 of an acrylate-modified siloxane oligomer.

—Composition—

Acryloyloxypropyltrimethoxysilane (manufactured by Shin-Etsu Chemical Co., Ltd.): 15.0 parts
Methyltrimethoxysilane (manufactured by Shin-Etsu Chemical Co., Ltd.): 6.0 parts
Ethanol (manufactured by FUJIFILM Wako Pure Chemical Corporation): 17.5 parts
Acetic acid (manufactured by FUJIFILM Wako Pure Chemical Corporation): 3.6 parts
Water: 11.7 parts

Furthermore, the followings were stirred and mixed at 25° C. for 24 hours to obtain a coating solution 1 for forming a protective layer.
Hydrolyzate 1: 8.0 parts
Ethanol: 8.0 parts
Acrylate-modified acrylic resin A (weight-average molecular weight=20,000): 11 parts
UV absorber (Tinuvin 479-DW, manufactured by BASF, solid content: 40% by mass): 1 part
Acrylic resin (methyl methacrylate (MMA)/methacrylic acid (MAA)=60/40 (mass ratio), manufactured by Sigma-Aldrich Co. LLC, Mn=32,000): 6 parts
IRGACURE 127 (manufactured by BASF): 0.1 parts
F-553 (fluorine-based surfactant manufactured by DIC Corporation): 0.02 parts

The coating solution 1 for forming a protective layer was applied, with a wire bar coater, to a base material surface opposite to the surface on which the alignment layer 1/cholesteric liquid crystal layer 1/colored layer 1 had been formed, such that the layer thickness was 15 and dried at 120° C. for 2 minutes to form a protective layer 1.

<Formation of Pressure Sensitive Adhesive Layer 1>

An acrylic pressure sensitive adhesive liquid (SK-Dyne SG-50Y, manufactured by Soken Chemical & Engineering Co., Ltd.) was applied, with a comma coater, to the surface on which the colored layer 1 had been formed, and dried at 120° C. for 2 minutes, thereby forming a pressure sensitive adhesive layer 1 having a layer thickness of 25 μm and producing a laminate 1 (decorative film 1 for molding).

<Molding>

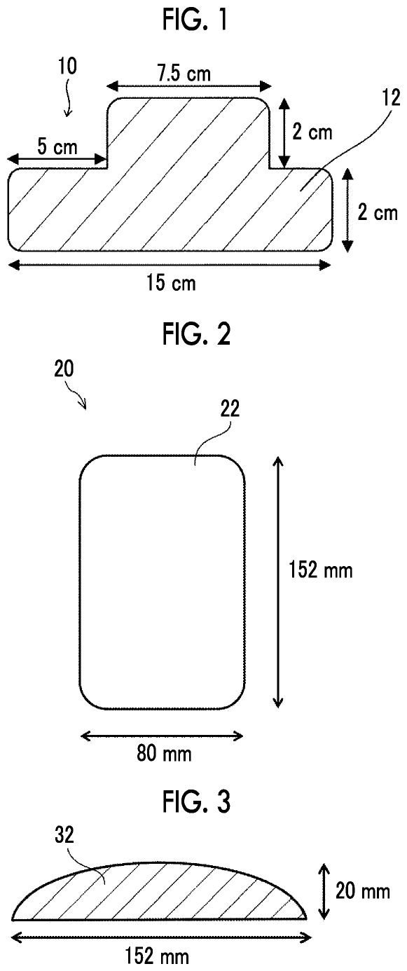

In order to obtain a molded article having a shape shown in FIG. 1, the laminate 1 was subjected to a compressed air molding (TOM molding). A TOM molding machine NGF-0510-R (manufactured by Fu-se Vacuum Forming) was used for the compressed air molding, and the molding temperature was set to 150° C. and the stretching ratio was set to 200% at the highest portion. The laminate 1 was cured by applying, using a light exposure device (nitrogen purge UV irradiator, manufactured by GS Yuasa International Ltd., metal halide lamp, output: 120 W/cm), an integrated exposure amount of 1,000 mJ/cm² to a surface in a molded article after molding, on which the protective layer 1 had been formed, thereby obtaining a molded article 1. In FIG. 1 10 is a molded article and 12 is a cross section.

<Performance Evaluation>

—Reflection Characteristics—

Using a spectrophotometer V-670 manufactured by JASCO Corporation, the reflectance of the laminate 1 before molding was measured in a wavelength range of 380 nm to 1,100 nm from the side of the protective layer 1 and from a direction perpendicular to the surface of the protective layer 1.

The highest value in the maximum values of the reflection spectrum was defined as the reflectance.

As an evaluation result, A, B, or C is preferable, A or B is more preferable, and A is particularly preferable.

<<Evaluation Standard>>

A: reflectance was 20% or more.

B: reflectance was 10% or more and less than 20%.

C: reflectance was 5% or more and less than 10%.

D: reflectance was less than 5%.

—Change in Reflectance—

Using a spectrophotometer V-670 manufactured by JASCO Corporation, with regard to the laminate 1 (not stretched) and a portion cut off from the molded article 1, where the stretching ratio was 100%, the reflection spectrum was measured in a wavelength range of 380 nm to 1,100 nm, and the change in reflectance was confirmed.

As an evaluation result, it is preferable that the change in reflectance is small, and A, B, or C is preferable.

Change in reflectance (%)=(reflectance of portion of molded article 1, where stretching ratio is 100%)/(reflectance of laminate 1)×100

<<Evaluation Standard>>

A: change in reflectance was 20% or less.

B: change in reflectance was more than 20% and 50% or less.

C: change in reflectance was more than 50% and less than 90%.

D: change in reflectance was 90% or more and less than 98%.

E: change in reflectance was 98% or more.

—Change in Tint—

With regard to the obtained molded article 1, the difference in tint between a portion where the stretching ratio was 0% and a portion where the stretching ratio was 100% was visually evaluated. As an evaluation result, A, B, or C is preferable, A or B is more preferable, and A is particularly preferable.

<<Evaluation Standard>>

A: no change in tint could be confirmed between the portion where the stretching ratio was 0% and the portion where the stretching ratio was 100%.

B: change in tint could be confirmed between the portion where the stretching ratio was 0% and the portion where the stretching ratio was 100%, but it is slight.

C: change in tint was confirmed between the portion where the stretching ratio was 0% and the portion where the stretching ratio was 100%.

D: change in tint was strongly confirmed between the portion where the stretching ratio was 0% and the portion where the stretching ratio was 100%.

—Moldability—

The obtained molded article was visually observed, and the cracked state of the liquid crystal layer was observed.

As an evaluation result, A, B, or C is preferable, A or B is more preferable, and A is most preferable.

<<Evaluation Standard>>

A: cured film was not cracked in a region where the stretch ratio was 200% or more.

B: cured film was not cracked in a region where the stretch ratio was less than 150%, but the cured film was cracked in a region where the stretch ratio was 150% or more.

C: cured film was not cracked in a region where the stretch ratio was less than 100%, but the cured film was cracked in a region where the stretch ratio was 100% or more.

D: cured film was not cracked in a region where the stretch ratio was less than 50%, but the cured film was cracked in a region where the stretch ratio was 50% or more.

E: cured film was cracked in a region where the stretch ratio was less than 50%.

—Chipping Resistance—

A test piece having a length of 7 cm and a width of 5 cm was cut out from a part of the molded article 1. Using a graverometer (manufactured by Suga Test Instruments Co., Ltd., JA-400S type), the obtained test piece was collided with 100 g of No. 7 crushed stone at a pressure of 0.3 MPa in an environment of a test temperature of 0° C. Thereafter, the surface of the test piece was observed. Chipping resistance of the molded article 1 was evaluated based on the following standard. As an evaluation result, A, B, or C is preferable, A or B is more preferable, and A is most preferable.

<<Evaluation Standard>>

A: no scratches spread around a part where the crushed stone collided were observed by visual observation and optical microscope observation (magnification: 500 times) (that is, scratches were observed only in the part where the crushed stone collided).

B: scratches spread to a range of 200 μm around a part where the crushed stone collided were observed by optical microscope observation (magnification: 500 times), but no scratches spread around the part where the crushed stone collided were observed by visual observation.

C: scratches spread to a range of 500 μm or more around a part where the crushed stone collided were observed by optical microscope observation (magnification: 500 times), but no scratches spread around the part where the crushed stone collided were observed by visual observation.

D: deterioration (for example, cracking or peeling) was observed by visual observation.

E: significant deterioration (for example, cracking or peeling) was observed by visual observation.

The evaluation results are summarized in Table 1.

### Examples 2 to 20 and Comparative Examples 1 to 5

Laminates 2 to 20 and C1 to C5 (decorative films for molding 2 to 20 and C1 to C5) and molded articles 2 to 20 and C1 to C5 were respectively produced in the same manner as in Example 1, except that composition of coating solution 1 of the cholesteric liquid crystal layer was changed to composition shown in Table 1 or Table 2.

In addition, the evaluations were performed by the same method as in Example 1. The evaluation results are summarized in Table 1 and Table 2.

TABLE 1

| | | | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 | ple 11 | ple 12 |
| Liquid | Liquid | Mono- | 92 | 94 | 96 | 96 | 92 | 88 | 82 | 62 | 42 | 32 | 82 | 62 |
| crystal | compound | func- | | | | | | | | | | | | |
| compound | 1 | tional | | | | | | | | | | | | |
| | Liquid | Mono- | — | — | — | — | — | — | — | — | — | — | — | — |
| | compound | func- | | | | | | | | | | | | |
| | 4 | tional | | | | | | | | | | | | |
| | Liquid | Mono- | — | — | — | — | — | — | — | — | — | — | — | — |
| | compound | func- | | | | | | | | | | | | |
| | 5 | tional | | | | | | | | | | | | |
| | Liquid | Mono- | — | — | — | — | — | — | — | — | — | — | — | — |
| | compound | func- | | | | | | | | | | | | |
| | 6 | tional | | | | | | | | | | | | |
| | Liquid | Bi- | — | — | — | — | — | 4 | 10 | 30 | 50 | 60 | — | — |
| | compound | func- | | | | | | | | | | | | |
| | 2 | tional | | | | | | | | | | | | |
| | Liquid | Non- | — | — | — | — | — | — | — | — | — | — | 10 | 30 |
| | compound | func- | | | | | | | | | | | | |
| | 3 | tional | | | | | | | | | | | | |
| | Chiral | Bi- | 4 | 3 | 4 | 2 | — | — | 4 | 4 | 4 | 4 | 4 | 4 |
| | agent A | func- | | | | | | | | | | | | |
| | | tional | | | | | | | | | | | | |
| | Chiral | Non- | 4 | 3 | — | 2 | 8 | 8 | 4 | 4 | 4 | 4 | 4 | 4 |
| | agent B | func- | | | | | | | | | | | | |
| | | tional | | | | | | | | | | | | |
| | Chiral | Non- | — | — | — | — | — | — | — | — | — | — | — | — |
| | agent C | func- | | | | | | | | | | | | |
| | | tional | | | | | | | | | | | | |

| | | | | | | | | | | | | | |
|---|---|---|---|---|---|---|---|---|---|---|---|---|---|
| Photo- | Irgacure 907 | 0.5 | 0.5 | 0.5 | 0.5 | 0.5 | 0.5 | 0.5 | 0.5 | 0.5 | 0.5 | 0.5 | 0.5 |
| polymer- | CPI-100P | — | — | — | — | — | — | — | — | — | — | — | — |
| ization | | | | | | | | | | | | | |
| initiator | | | | | | | | | | | | | |

| Specific liquid crystal | | 92% | 94% | 96% | 96% | 92% | 88% | 82% | 62% | 42% | 32% | 82% | 62% |
|---|---|---|---|---|---|---|---|---|---|---|---|---|---|
| compound ratio | | | | | | | | | | | | | |
| Polyfunctional polymerizable | | 4% | 3% | 4% | 2% | 0% | 4% | 14% | 34% | 54% | 64% | 4% | 4% |
| compound ratio | | | | | | | | | | | | | |
| Tint before | Reflection | A | A | A | A | B | A | A | A | A | A | A | B |
| molding | charac- | | | | | | | | | | | | |
| | teristics | | | | | | | | | | | | |
| | Color | Blue | Green | Red | Red | Blue | Blue | Blue | Blue | Blue | Blue | Blue | Blue |
| Tint after | Change in | A | A | A | A | B | B | A | B | B | C | A | A |
| molding | reflectance | | | | | | | | | | | | |
| (stretching ratio | Change in | C | C | C | C | C | C | C | C | C | C | C | C |
| dependence) | tint | | | | | | | | | | | | |

| | | | | | | | | | | | | |
|---|---|---|---|---|---|---|---|---|---|---|---|---|
| Moldability | A | A | A | A | A | A | B | B | C | C | A | A |
| Chipping resistance | A | A | A | A | A | A | B | B | B | C | A | A |

TABLE 2

| | | | Exam- | Exam- | Exam- | Exam- | Exam- | Exam- | Exam- | Exam- |
|---|---|---|---|---|---|---|---|---|---|---|
| | | | ple 13 | ple 14 | ple 15 | ple 16 | ple 17 | ple 18 | ple 19 | ple 20 |
| Liquid | Liquid | Mono- | 42 | 32 | 30 | 92 | — | 92 | — | — |
| crystal | compound | func- | | | | | | | | |
| compound | 1 | tional | | | | | | | | |
| | Liquid | Mono- | — | — | — | — | 92 | — | — | — |
| | compound | func- | | | | | | | | |
| | 4 | tional | | | | | | | | |
| | Liquid | Mono- | — | — | — | — | — | — | 92 | — |
| | compound | func- | | | | | | | | |
| | 5 | tional | | | | | | | | |
| | Liquid | Mono- | — | — | — | — | — | — | — | 92 |
| | compound | func- | | | | | | | | |
| | 6 | tional | | | | | | | | |
| | Liquid | Bi- | — | — | 30 | — | — | — | — | — |
| | compound | func- | | | | | | | | |
| | 2 | tional | | | | | | | | |
| | Liquid | Non- | 50 | 60 | 32 | — | — | — | — | — |
| | compound | func- | | | | | | | | |
| | 3 | tional | | | | | | | | |
| | Chiral | Bi- | 4 | 4 | 4 | — | 4 | — | 4 | 4 |
| | agent A | func- | | | | | | | | |
| | | tional | | | | | | | | |
| | Chiral | Non- | 4 | 4 | 4 | 8 | 4 | — | 4 | 4 |
| | agent B | func- | | | | | | | | |
| | | tional | | | | | | | | |
| | Chiral | Non- | — | — | — | — | — | 8 | — | — |
| | agent C | func- | | | | | | | | |
| | | tional | | | | | | | | |

| | | | | | | | | | |
|---|---|---|---|---|---|---|---|---|---|
| Photo- | Irgacure 907 | 0.5 | 0.5 | 0.5 | — | 0.5 | 0.5 | 0.5 | 0.5 |
| polymer- | CPI-100P | — | — | — | 0.5 | — | — | — | — |
| ization | | | | | | | | | |
| initiator | | | | | | | | | |

| Specific liquid crystal | | 42% | 32% | 30% | 92% | 92% | 92% | 92% | 92% |
|---|---|---|---|---|---|---|---|---|---|
| compound ratio | | | | | | | | | |
| Polyfunctional polymerizable | | 4% | 4% | 34% | 0% | 4% | 0% | 4% | 4% |
| compound ratio | | | | | | | | | |
| Tint before | Reflection | B | C | B | B | A | B | A | B |
| molding | charac- | | | | | | | | |
| | teristics | | | | | | | | |
| | Color | Blue | Blue | Blue | Blue | Blue | Blue | Blue | Blue |
| Tint after | Change in | B | C | B | B | A | B | A | B |
| molding | reflectance | | | | | | | | |
| (stretching ratio | Change in | C | C | C | C | C | C | C | C |
| dependence) | tint | | | | | | | | |

| | | | | | | | | |
|---|---|---|---|---|---|---|---|---|
| Moldability | A | A | B | A | A | A | A | A |
| Chipping resistance | B | C | B | A | A | A | A | A |

| | | | Compar- | Compar- | Compar- | Compar- | Compar- |
|---|---|---|---|---|---|---|---|
| | | | ative | ative | ative | ative | ative |
| | | | Exam- | Exam- | Exam- | Exam- | Exam- |
| | | | ple 1 | ple 2 | ple 3 | ple 4 | ple 5 |
| Liquid | Liquid | Mono- | — | — | 20 | 20 | — |
| crystal | compound | func- | | | | | |
| compound | 1 | tional | | | | | |
| | Liquid | Mono- | — | — | — | — | — |
| | compound | func- | | | | | |
| | 4 | tional | | | | | |
| | Liquid | Mono- | — | — | — | — | — |
| | compound | func- | | | | | |
| | 5 | tional | | | | | |
| | Liquid | Mono- | — | — | — | — | — |
| | compound | func- | | | | | |
| | 6 | tional | | | | | |
| | Liquid | Bi- | 92 | — | — | 72 | 40 |
| | compound | func- | | | | | |
| | 2 | tional | | | | | |
| | Liquid | Non- | — | 92 | 72 | — | 56 |
| | compound | func- | | | | | |
| | 3 | tional | | | | | |
| | Chiral | Bi- | 4 | 4 | 4 | 4 | 4 |
| | agent A | func- | | | | | |
| | | tional | | | | | |
| | Chiral | Non- | 4 | 4 | 4 | 4 | 4 |
| | agent B | func- | | | | | |
| | | tional | | | | | |
| | Chiral | Non- | — | — | — | — | — |
| | agent C | func- | | | | | |
| | | tional | | | | | |

| | | | | | | |
|---|---|---|---|---|---|---|
| Photo- | Irgacure 907 | — | — | — | — | — |
| polymer- | CPI-100P | — | — | — | — | — |
| ization | | | | | | |
| initiator | | | | | | |

| Specific liquid crystal | | 0% | 0% | 20% | 20% | 0% |
|---|---|---|---|---|---|---|
| compound ratio | | | | | | |
| Polyfunctional polymerizable | | 96% | 4% | 4% | 76% | 44% |
| compound ratio | | | | | | |
| Tint before | Reflection | A | D | C | A | B |
| molding | charac- | | | | | |
| | teristics | | | | | |
| | Color | Blue | Black | Blue | Blue | Blue |
| Tint after | Change in | E | — | D | D | D |
| molding | reflectance | | | | | |
| (stretching ratio | Change in | D | — | C | D | C |
| dependence) | tint | | | | | |

| | | | | | |
|---|---|---|---|---|---|
| Moldability | E | — | A | D | C |
| Chipping resistance | E | D | D | E | D |

The reflected color in Table 1 and Table 2, and Table 3 described later indicate a color which is viewed in a case where the laminate (decorative film for molding) is viewed from the protective layer side.

The numerical unit of each component shown in Table 1 and Table 2 represents part by mass.

The “Specific liquid crystal compound ratio” in Table 1 and Table 2 represents the content of the cholesteric liquid crystal compound having one ethylenic unsaturated group or one cyclic ether group with respect to the total solid content of the liquid crystal composition.

In addition, the “Polyfunctional polymerizable compound ratio” in Table 1 and Table 2 represents the content of the polyfunctional polymerizable compound with respect to the total solid content of the liquid crystal composition.

The abbreviations shown in Table 1 and Table 2, other than those described above, are shown below.

Liquid crystal compound 2 (bifunctional): rod-like liquid crystal compound shown below, 1,4-bis [4-(3-acryloyloxypropoxy)benzoyloxy]-2-methylbenzene, manufactured by Tokyo Chemical Industry Co., Ltd.

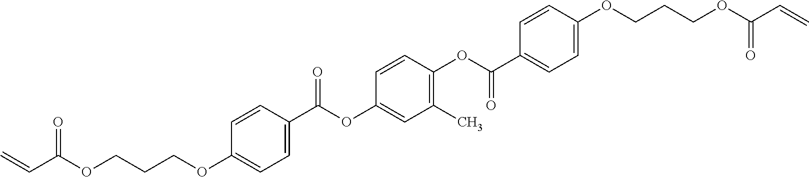 [SMILES: C=CC(=O)OCCCOc1ccc(C(=O)Oc2ccc(OC(=O)c3ccc(OCCCOC(=O)C=C)cc3)c(C)c2)cc1]

Liquid crystal compound 3 (non-functional): rod-like liquid crystal compound shown below

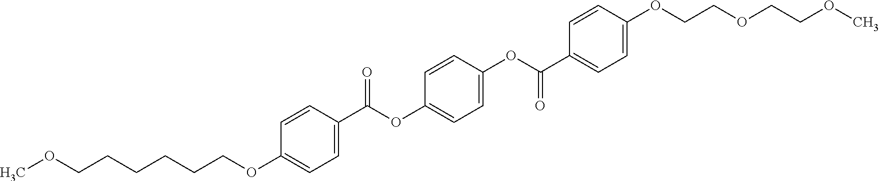

Liquid crystal compound 4 (monofunctional): rod-like liquid crystal compound shown below, 4-cyanophenyl 4-(3-butenyloxy)benzoate, manufactured by Tokyo Chemical Industry Co., Ltd.

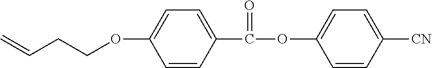 [SMILES: C=CCCOc1ccc(C(=O)Oc2ccc(C#N)cc2)cc1]

Liquid crystal compound 5 (monofunctional): rod-like liquid crystal compound shown below

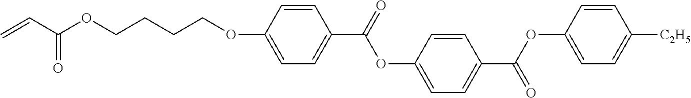 [SMILES: C=CC(=O)OCCCCOc1ccc(C(=O)Oc2ccc(C(=O)Oc3ccc(CC)cc3)cc2)cc1]

Liquid crystal compound 6 (monofunctional): rod-like liquid crystal compound shown below

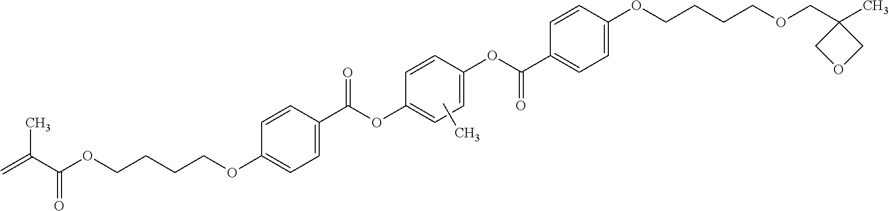

Chiral agent C (non-functional): compound shown below; in the following compound, Bu represents an n-butyl group.

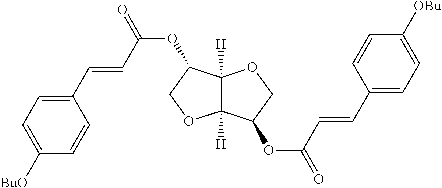

CPI-100P: photocationic polymerization initiator, sulfonium salt compound, manufactured by San-Apro Ltd.

### Example 21

A laminate 21 (decorative film 21 for molding) was produced so as to have a layer configuration of pressure sensitive adhesive layer 1/colored layer 1/cholesteric liquid crystal layer 1/alignment layer 1/base material/colored layer 2/protective layer 1.

The laminate 21 was produced by the same method as in Example 1, except that the colored layer 2 was formed on the base material before the protective layer 1 was formed.

<Formation of Colored Layer 2>

A coating solution for forming a colored layer 2 was applied to a base material surface opposite to the surface on which the alignment layer 1/cholesteric liquid crystal layer 1/colored layer 1 had been formed, and dried at 100° C. for 10 minutes to form a colored layer 2 having a layer thickness of 5 μm.

Each component shown below was stirred and dissolved in a container kept at 25° C. to prepare a coating solution for the colored layer 2.

[Composition of coating solution for forming colored layer 2]
NX-042 violet (manufactured by Dainichiseika Color & Chemicals Mfg. Co., Ltd.): 20% by mass
Methyl ethyl ketone (MEK): 80% by mass

Using the obtained laminate 21, a molded article 21 was produced by the same method as in Example 1.

In addition, the evaluations were performed by the same method as in Example 1. The evaluation results are shown in Table 3.

### Example 22

A laminate 22 (decorative film 22 for molding) was produced so as to have a layer configuration of pressure sensitive adhesive layer 1/colored layer 1/cholesteric liquid crystal layer 1/alignment layer 1/base material/alignment layer 2/cholesteric liquid crystal layer 2/colored layer 2/protective layer 1.

The laminate 22 was produced by the same method as in Example 21, except that the alignment layer and the cholesteric liquid crystal layer were formed not only on one side of the base material but also on both sides.

The alignment layer 2 and the cholesteric liquid crystal layer 2 formed on the base material on the colored layer 2 side were formed by the same composition and method as those of the alignment layer 1 and the cholesteric liquid crystal layer 1, respectively.

Using the obtained laminate 22, a molded article 22 was produced by the same method as in Example 1.

In addition, the evaluations were performed by the same method as in Example 1. The evaluation results are shown in Table 3.

### Example 23

A laminate 23 (decorative film 23 for molding) was produced so as to have a layer configuration of pressure sensitive adhesive layer 1/base material/alignment layer 1/cholesteric liquid crystal layer 1/protective layer 1.

The laminate 23 was produced by the same method as in Example 1, except that the colored layer 1 was not formed.

Using the obtained laminate 23, a molded article 23 was produced by the same method as in Example 1.

In addition, the evaluations were performed by the same method as in Example 1. The evaluation results are shown in Table 3.

### Example 24

A laminate 24 (decorative film 24 for molding) was produced so as to have a layer configuration of pressure sensitive adhesive layer 1/cholesteric liquid crystal layer 1/alignment layer 1/base material.

The laminate 24 was produced by the same method as in Example 1, except that the colored layer 1 and the protective layer 1 were not formed, and the pressure sensitive adhesive layer 1 was formed on the cholesteric liquid crystal layer 1 side.

Using the obtained laminate 24, a molded article 24 was produced by the same method as in Example 1.

In addition, the evaluations were performed by the same method as in Example 1. The evaluation results are shown in Table 3.

TABLE 3

| | | Example 1 | Example 21 | Example 22 | Example 23 | Example 24 |
|---|---|---|---|---|---|---|
| Tint before molding | Reflection | A | A | A | A | A |
| | characteristics | | | | | |
| | Color | Blue | Blue | Blue | Blue | Blue |
| Tint after molding | Change in | A | A | A | A | A |
| (stretching ratio | reflectance | | | | | |
| dependence) | Change in tint | C | B | A | A | A |

| | | | | | |
|---|---|---|---|---|---|
| Moldability | A | A | A | A | A |
| Chipping resistance | A | A | A | B | C |

### Example 25

A laminate 25 was produced by the same method as in Example 1, except that the base material was changed to TECHNOLLOY 5001 (acrylic resin, film thickness: 125 μm, manufactured by Sumika Acryl Co., Ltd.).

Using the obtained laminate 25, a molded article 25 was produced by the same method as in Example 1.

In addition, the evaluations were performed by the same method as in Example 1. The evaluation results are shown in Table 4.

### Example 26

A laminate 26 was produced by the same method as in Example 1, except that the base material was changed to COSMOSHINE A4300 (amorphous polyethylene terephthalate (A-PET), film thickness: 75 μm, manufactured by TOYOBO Co., Ltd.).

Using the obtained laminate 26, a molded article 26 was produced by the same method as in Example 1.

In addition, the evaluations were performed by the same method as in Example 1. The evaluation results are shown in Table 4.

### Example 27

A laminate 27 was produced by the same method as in Example 1, except that the base material was changed to Purethermo (polypropylene (PP), film thickness: 125 μm, manufactured by Idemitsu Unitech Co., Ltd.).

Using the obtained laminate 27, a molded article 27 was produced by the same method as in Example 1.

In addition, the evaluations were performed by the same method as in Example 1. The evaluation results are shown in Table 4.

### Example 28

An acrylic pressure sensitive adhesive liquid (SK-Dyne SG-50Y, manufactured by Soken Chemical & Engineering Co., Ltd.) was applied, with a comma coater, to a base material surface opposite to the surface on which the alignment layer 1/cholesteric liquid crystal layer 1/colored layer 1 had been formed, and dried at 120° C. for 2 minutes, thereby forming a pressure sensitive adhesive layer 2 having a layer thickness of 25 μm. Furthermore, a laminate 28 was produced by the same method as in Example 1, except that a protective layer 2 was formed by laminating an ethylene-tetrafluoroethylene copolymer (ETFE) film (NEOFLON ETFE, layer thickness: 12.5 μm, manufactured by DAIKIN INDUSTRIES, LTD.) on the pressure sensitive adhesive layer 2.

Using the obtained laminate 28, a molded article 28 was produced by the same method as in Example 1.

In addition, the evaluations were performed by the same method as in Example 1. The evaluation results are shown in Table 4.

### Example 29

A laminate 29 was produced by the same method as in Example 1, except that the following coating solution 3 for forming a protective layer was dried at 100° C. for 10 minutes on a base material surface opposite to the surface on which the alignment layer 1/cholesteric liquid crystal layer 1/colored layer 1 had been formed, thereby forming a protective layer 3 having a layer thickness of 10 μm. The method for preparing the coating solution 3 for forming a protective layer is shown below.

Using the obtained laminate 29, a molded article 29 was produced by the same method as in Example 1.

In addition, the evaluations were performed by the same method as in Example 1. The evaluation results are shown in Table 4.

<Preparation of Coating Solution 3 for Forming Protective Layer>

Each component shown below was stirred and dissolved in a container kept at 25° C. to prepare a coating solution 3 for forming a protective layer.

—Composition of Coating Solution 3 for Forming Protective Layer—

The composition shown below was stirred and dissolved in a container kept at 25° C. to prepare a coating solution 3 for forming a protective layer.
Acrit 8UH-1094 (urethane acrylate, manufactured by Taisei Fine Chemical Co., Ltd., solid content: 45%): 45 parts
IRGACURE 127 (manufactured by BASF): 1.5 parts
MEK: 53.5 parts

### Example 30

A laminate 30 was produced by the same method as in Example 1, except that the following coating solution for forming a UV absorbing layer 1 was applied, with a wire bar coater, to a base material surface opposite to the surface on which the alignment layer 1/cholesteric liquid crystal layer 1/colored layer 1 had been formed, such that the layer thickness was 8 μm, and was dried at 140° C. for 2 minutes to form a UV absorbing layer 1, and then the protective layer 1 was formed on the UV absorbing layer 1 under the same conditions as in Example 1. The method for preparing the coating solution for forming a UV absorbing layer 1 is shown below.

Using the obtained laminate 30, a molded article 30 was produced by the same method as in Example 1.

In addition, the evaluations were performed by the same method as in Example 1. The evaluation results are shown in Table 4.

<Preparation of Coating Solution for Forming UV Absorbing Layer 1>

The composition shown below was stirred and dissolved in a container kept at 25° C. to prepare a coating solution for forming a UV absorbing layer 1.

—Composition of Coating Solution for Forming UV Absorbing Layer 1—
UV absorber (Tinuvin 479-DW, manufactured by BASF, solid content: 40% by mass): 7.1 part
Aqueous dispersion liquid of binder polymer (acrylic resin, AS-563A, manufactured by DAICEL MIRAIZU LTD., solid content: 28% by mass): 37.5 parts
Water-soluble oxazoline-based crosslinking agent (Epocros WS-700, manufactured by NIPPON SHOKUBAI CO., LTD., solid content: 25% by mass): 1.0 part
Water: remaining amount of 100 parts in total

### Example 31

A laminate 31 was produced by the same method as in Example 1, except that the colored layer 1 was changed to the following colored layer 1 (red colored layer).

Using the obtained laminate 31, a molded article 31 was produced by the same method as in Example 1.

In addition, the evaluations were performed by the same method as in Example 1. The evaluation results are shown in Table 4.

<Formation of Colored Layer 1 (Red Colored Layer)>

A black paint (Nax REAL 596 manufactured by NIPPONPAINT Co., Ltd.) was dried at 100° C. for 10 minutes on the formed cholesteric liquid crystal layer to form a colored layer 1 (red colored layer) having a layer thickness of 10 μm.

### Example 32

A laminate 32 was produced by the same method as in Example 1, except that the colored layer 1 was changed to the following colored layer 1 (metallic colored layer).

Using the obtained laminate 32, a molded article 32 was produced by the same method as in Example 1.

In addition, the evaluations were performed by the same method as in Example 1. The evaluation results are shown in Table 4.

<Formation of Colored Layer 1 (Metallic Colored Layer)>

A metallic paint (MIR 51000 manufactured by Teikoku Printing Inks Mfg. Co., Ltd.) was dried at 100° C. for 10 minutes on the formed cholesteric liquid crystal layer to form a colored layer 1 (metallic colored layer) having a layer thickness of 10 μm.

### Examples 33 to 35

Laminates 33 to 35 were produced by the same method as in Example 1, except that the layer thickness in a case of forming the cholesteric liquid crystal layer was changed as shown in Table 4.

Using the obtained laminates 33 to 35, molded articles 33 to 35 were produced by the same method as in Example 1.

In addition, the evaluations were performed by the same method as in Example 1. The evaluation results are shown in Table 4.

### Example 36

A molded article 36 was produced in the same manner as in Example 33, except that, in Example 33, the base material was changed to the following acrylic film 2 with an easy-adhesive layer, the coating solution 1 for forming a protective layer in a case of forming the protective layer was changed to the following coating solution 4 for forming a protective layer, the surface to which the alignment film was applied was changed to an easy-adhesive layer surface of the acrylic film 2 with easy-adhesive layer, the coating solution for forming an alignment layer 1 in a case of forming the alignment layer was changed to the following coating solution for forming an alignment layer 3, and the black paint in a case of forming the black layer was changed to the following coating solution 3 for forming a black layer.

In addition, the evaluations were performed by the same method as in Example 1. The evaluation results are shown in Table 4.

<Production of Acrylic Film 2 (Base Material) with Easy-Adhesive Layer>

99 parts of methyl methacrylate (manufactured by FUJIFILM Wako Pure Chemical Corporation), 1 part of methacrylic acid (manufactured by FUJIFILM Wako Pure Chemical Corporation), and 0.1 parts of a V-601 initiator (manufactured by FUJIFILM Wako Pure Chemical Corporation) were mixed and reacted at 60° C. in MEK to obtain a copolymer (A) (Mw=100,000).

82 parts of the obtained copolymer (A), 14 parts of rubber elastic particles (METABLEN W450A, manufactured by Mitsubishi Chemical Corporation.), and 4 parts of a UV absorber (ADK STAB LA-31G, manufactured by ADEKA CORPORATION) were put in an extruder, and the mixture was melt-kneaded at 230° C. for an average residence time of 10 minutes to obtain resin pellets of a UV absorber-containing acrylic resin composition.

The obtained resin pellets of the acrylic resin composition were melt-kneaded in the extruder at 245° C., extrusion-molded into a film, and cooled. In this way, an acrylic resin film having a thickness of 150 μm was obtained.

The following coating solution for forming an easy-adhesive layer was applied to one surface of the obtained acrylic resin film such that the film thickness was 0.5 μm, and dried at 80° C. for 2 minutes. Thereafter, the film was cured by applying, using a light exposure device (nitrogen purge UV irradiator, manufactured by GS Yuasa International Ltd., metal halide lamp, output: 120 W/cm), an integrated exposure amount of 200 mJ/cm² to the film, thereby obtaining the acrylic film 2 with an easy-adhesive layer.

—Preparation of Coating Solution 1 Forming Easy-Adhesive Layer—
MEK (manufactured by FUJIFILM Wako Pure Chemical Corporation): 85.1 parts by mass
CN996NS (urethane acrylate, solid content: 50%, manufactured by Sartomer Japan Inc.): 14.8 parts by mass
OXE-02 (ultraviolet (UV) absorber, manufactured by BASF): 0.03 parts by mass
F551A (surfactant, manufactured by DIC Corporation): 0.014 parts by mass

—Preparation of Coating Solution 4 for Forming Protective Layer—

The following materials were stirred and mixed at 25° C. for 24 hours to obtain a hydrolyzate 2 of an acrylate-modified siloxane oligomer.

[Composition]
KR513 (acrylate-modified trimethoxysilane condensate, manufactured by Shin-Etsu Chemical Co., Ltd.): 19.0 parts
Ethanol (manufactured by FUJIFILM Wako Pure Chemical Corporation): 17.5 parts
Acetic acid (manufactured by FUJIFILM Wako Pure Chemical Corporation): 3.6 parts
Water: 11.7 parts

Furthermore, components having the following composition were stirred and mixed at 25° C. for 24 hours to obtain a coating solution 4 for forming a protective layer.

[Composition]
Hydrolyzate 2: 28.5 parts
Ethanol: 9.6 parts
Acrit KX-077 (weight-average molecular weight=28,000): 50.0 parts
Aluminum Chelate D (curing agent, manufactured by Kawaken Fine Chemicals Co., Ltd.): 2.0 parts
IRGACURE 127 (manufactured by BASF): 1.0 parts
F-553 (fluorine-based surfactant manufactured by DIC Corporation): 0.02 parts

<Formation of Alignment Layer 3>

The alignment layer 3 was formed by applying a coating solution to the acrylic surface of the base material with a wire bar coater, and then drying at 100° C. for 120 seconds. The layer thickness of the alignment layer 3 was 1.5

[Composition of Coating Solution for Forming Alignment Layer 3]
Modified polyvinyl alcohol shown below: 28 parts by mass
Citric acid ester (AS3, manufactured by SANKYO CHEMICAL Co., Ltd.): 1.2 parts by mass
Photopolymerization initiator (IRGACURE 2959, manufactured by BASF): 0.84 parts by mass
Glutaraldehyde: 2.8 parts by mass
PHENOLITE GG-1480 (resole resin, manufactured by DIC Corporation, solid content: 70%): 0.8 parts by mass
Water: 699 parts by mass
Methanol: 226 parts by mass
Modified polyvinyl alcohol (the following compounds; the numbers at the lower right of each constitutional unit represent the molar ratio)

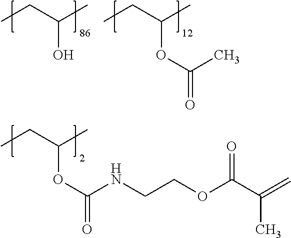

<Formation of Colored Layer 3>

A colored layer 3 (black colored layer) was formed by applying the following coating solution 3 for forming a black layer to the cholesteric liquid crystal layer, and then drying at 80° C. for 2 minutes. The layer thickness of the colored layer 3 was 10

[Composition of Coating Solution 3 for Forming Black Layer]
SF AG4251 (black dispersion, manufactured by Sanyo Color Works, LTD.): 35 parts
CN996NS (urethane acrylate, solid content: 50% by mass, manufactured by Sartomer Japan Inc.): 18 parts
8UA-6056 (urethane-modified acrylic polymer, solid content: 35% by mass, manufactured by Sartomer Japan Inc.): 36.0 parts
OXE-02 (photopolymerization initiator, manufactured by BASF): 0.1 parts
F551A (surfactant, manufactured by DIC Corporation): 0.08 parts

TABLE 4

| | | Example 1 | Example 25 | Example 26 | Example 27 | Example 28 | Example 29 | Example 30 |
|---|---|---|---|---|---|---|---|---|
| Protective layer | | Protective | Protective | Protective | Protective | Protective | Protective | Protective |
| | | layer 1 | layer 1 | layer 1 | layer 1 | layer 2 | layer 3 | layer 1 |
| | | (siloxane | (siloxane | (siloxane | (siloxane | (ETFE) | (urethane) | (siloxane |
| | | acryl) | acryl) | acryl) | acryl) | | | acryl) |
| Pressure sensitive | | — | — | — | | Pressure | — | — |
| adhesive layer | | | | | | sensitive | | |
| | | | | | | adhesive | | |
| | | | | | | layer 2 | | |
| UV absorbing layer | | — | — | — | — | — | — | UV |
| | | | | | | | | absorbing |
| | | | | | | | | layer 1 |
| Base material | | Poly- | Acryl | A-PET | PP | Poly- | Poly- | Poly- |
| | | carbonate/ | | | | carbonate/ | carbonate/ | carbonate/ |
| | | acryl | | | | acryl | acryl | acryl |
| Alignment layer | | Alignment | Alignment | Alignment | Alignment | Alignment | Alignment | Alignment |
| | | layer 1 | layer 1 | layer 1 | layer 1 | layer 1 | layer 1 | layer 1 |
| Cholesteric liquid | | Liquid | Liquid | Liquid | Liquid | Liquid | Liquid | Liquid |
| crystal layer | | crystal | crystal | crystal | crystal | crystal | crystal | crystal |
| | | layer 1 | layer 1 | layer 1 | layer 1 | layer 1 | layer 1 | layer 1 |
| Colored layer | | Colored | Colored | Colored | Colored | Colored | Colored | Colored |
| | | layer 1 | layer 1 | layer 1 | layer 1 | layer 1 | layer 1 | layer 1 |
| | | black | black | black | black | black | black | black |
| Pressure sensitive | | Pressure | Pressure | Pressure | Pressure | Pressure | Pressure | Pressure |
| adhesive layer | | sensitive | sensitive | sensitive | sensitive | sensitive | sensitive | sensitive |
| | | adhesive | adhesive | adhesive | adhesive | adhesive | adhesive | adhesive |
| | | layer 1 | layer 1 | layer 1 | layer 1 | layer 1 | layer 1 | layer 1 |
| Layer thickness of | | 1.4 | 1.4 | 1.4 | 1.4 | 1.4 | 1.4 | 1.4 |
| cholesteric | | | | | | | | |
| liquid crystal | | | | | | | | |
| layer (μm) | | | | | | | | |
| Tint before | Reflection | A | A | A | B | A | A | A |
| molding | characteristics | | | | | | | |
| | Color | Blue | Blue | Blue | Blue | Blue | Blue | Blue |
| Tint after | Change in | A | A | A | A | A | A | A |
| molding | reflectance | | | | | | | |
| (stretching | Change in | C | C | C | C | C | C | C |
| ratio | tint | | | | | | | |
| dependence) | | | | | | | | |

| | | | | | | | |
|---|---|---|---|---|---|---|---|
| Moldability | A | A | B | B | A | A | A |
| Chipping resistance | A | A | A | A | B | B | A |

| | | Example 31 | Example 32 | Example 33 | Example 34 | Example 35 | Example 36 |
|---|---|---|---|---|---|---|---|
| Protective layer | | Protective | Protective | Protective | Protective | Protective | Protective |
| | | layer 1 | layer 1 | layer 1 | layer 1 | layer 1 | layer 4 |
| | | (siloxane | (siloxane | (siloxane | (siloxane | (siloxane | (siloxane |
| | | acryl) | acryl) | acryl) | acryl) | acryl) | acryl) |
| Pressure sensitive | | — | — | — | — | — | — |
| adhesive layer | | | | | | | |
| UV absorbing layer | | — | — | — | — | — | — |
| Base material | | Poly- | Poly- | Poly- | Poly- | Poly- | Acryl (with |
| | | carbonate/ | carbonate/ | carbonate/ | carbonate/ | carbonate/ | easy- |
| | | acryl | acryl | acryl | acryl | acryl | adhesive |
| | | | | | | | layer) |
| Alignment layer | | Alignment | Alignment | Alignment | Alignment | Alignment | Alignment |
| | | layer 1 | layer 1 | layer 1 | layer 1 | layer 1 | layer 3 |
| Cholesteric liquid | | Liquid | Liquid | Liquid | Liquid | Liquid | Liquid |
| crystal layer | | crystal | crystal | crystal | crystal | crystal | crystal |
| | | layer 1 | layer 1 | layer 1 | layer 1 | layer 1 | layer 1 |
| Colored layer | | Colored | Colored | Colored | Colored | Colored | Colored |
| | | layer 1 | layer 1 | layer 1 | layer 1 | layer 1 | layer 3 |
| | | red | metallic | black | black | black | black |
| Pressure sensitive | | Pressure | Pressure | Pressure | Pressure | Pressure | Pressure |
| adhesive layer | | sensitive | sensitive | sensitive | sensitive | sensitive | sensitive |
| | | adhesive | adhesive | adhesive | adhesive | adhesive | adhesive |
| | | layer 1 | layer 1 | layer 1 | layer 1 | layer 1 | layer 1 |
| Layer thickness of | | 1.4 | 1.4 | 0.6 | 3 | 10 | 0.6 |
| cholesteric | | | | | | | |
| liquid crystal | | | | | | | |
| layer (μm) | | | | | | | |
| Tint before | Reflection | A | A | B | A | B | A |
| molding | characteristics | | | | | | |
| | Color | Violet | Blue | Blue | Blue | Blue | Blue |
| | | | (high- | | | | |
| | | | brightness) | | | | |
| Tint after | Change in | A | A | B | A | A | A |
| molding | reflectance | | | | | | |
| (stretching | Change in | C | C | C | C | C | C |
| ratio | tint | | | | | | |
| dependence) | | | | | | | |

| | | | | | | |
|---|---|---|---|---|---|---|
| Moldability | A | B | A | A | A | A |
| Chipping resistance | A | A | A | A | A | A |

In Table 4, the “siloxane acryl” in the column of protective layer represents a resin having a polysiloxane structure and an acrylic resin structure, the “acryl” in the column of base material represents an acrylic resin, and the color shown in the column of colored layer represents the color of the colored layer, respectively.

As shown in Tables 1 to 4, compared with the decorative films for molding of Comparative Examples 1 to 5, the decorative films for molding of Examples 1 to 36 had a smaller change in reflectance after molding.

In addition, the decorative films for molding of Examples 1 to 36 had a small change in tint after molding, were excellent in moldability, and were also excellent in chipping resistance after curing.

Furthermore, in a case of being visually observed, the decorative films for molding of Examples 1 to 36 were also excellent in uniformity of brightness not only before molding but also after molding.

### Example 37

A laminate in which an alignment layer 1/cholesteric liquid crystal layer 1/colored layer 1 was formed on a base material was produced in the same manner as in Example 1. Thereafter, a laminate 37 was produced by forming a pressure sensitive adhesive layer 1 on the base material surface opposite to the colored layer 1, without forming a protective layer.

The laminate 37 was subjected to molding in the same manner as in Example 1 to produce a molded article 37, except that the shape of the molded article was changed to the shape shown in FIGS. 2 and 3. In FIG. 2, 20 is a molded article and 22 is a main surface. In FIG. 3, 32 is a cross section.

In addition, the evaluations with regard to the reflection characteristics and color before molding, and change in reflectance after molding were performed by the same method as in Example 1. In addition, with regard to the moldability, the obtained molded article was visually observed, and the evaluation was performed whether or not the cured film was cracked in a region where the stretch ratio was 100%. The evaluation results are shown in Table 5.

### Example 38

A laminate 38 and a molded article 38 were produced by the same method as in Example 37, except that a coating solution for a cholesteric liquid crystal layer having the same composition as in Example 2 was used.

In addition, the evaluations were performed by the same method as in Example 37. The evaluation results are shown in Table 5.

### Example 39

A laminate 39 and a molded article 39 were produced by the same method as in Example 37, except that a coating solution for a cholesteric liquid crystal layer having the same composition as in Example 3 was used.

In addition, the evaluations were performed by the same method as in Example 37. The evaluation results are shown in Table 5.

TABLE 5

| | | | Example 37 | Example 38 | Example 39 |
|---|---|---|---|---|---|
| Liquid crystal | Liquid crystal | Monofuctional | 92 | 94 | 96 |
| compound | compound 1 | | | | |
| | Chiral agent A | Bifunctional | 4 | 3 | 4 |
| | Chiral agent B | Non-functional | 4 | 3 | — |
| | Chiral agent C | Non-functional | — | — | — |

| | | | | |
|---|---|---|---|---|
| Photopolymerization | Irgacure 907 | 0.5 | 0.5 | 0.5 |
| initiator | CPI-100P | — | — | — |

| Specific liquid crystal compound ratio | | 92% | 94% | 96% |
|---|---|---|---|---|
| Polyfunctional polymerizable compound ratio | | 4% | 3% | 4% |
| Tint before molding | Reflection | A | A | A |
| | characteristics | | | |
| | Color | Blue | Green | Red |
| Tint after molding | Change in | A | A | A |
| | reflectance | | | |

| | | | |
|---|---|---|---|
| Moldability | Not cracked | Not cracked | Not cracked |

As shown in Table 5, it was found that the decorative films for molding of Examples 37 to 39 had a small change in reflectance after molding.

The disclosure of JP2018-234492 filed on Dec. 14, 2018 and the disclosure of JP2019-097758 filed on May 24, 2019 are incorporated in the present specification by reference. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. A decorative film for molding, the decorative film comprising:
a cholesteric liquid crystal layer disposed on a base material,
wherein the cholesteric liquid crystal layer is formed by curing a liquid crystal composition that includes, with respect to a total solid content of the liquid crystal composition, 25% by mass or more of a cholesteric liquid crystal compound having one ethylenic unsaturated group or one cyclic ether group.

2. The decorative film for molding according to claim 1, further comprising a colored layer disposed between the base material and the cholesteric liquid crystal layer.

3. The decorative film for molding according to claim 1, further comprising a colored layer disposed on the cholesteric liquid crystal layer at an opposite side from a side at which the base material is disposed.

4. The decorative film for molding according to claim 1, wherein the liquid crystal composition includes, with respect to the total solid content of the liquid crystal composition, 25% by mass or more of a cholesteric liquid crystal compound having one ethylenic unsaturated group.

5. The decorative film for molding according to claim 1, wherein the liquid crystal composition includes a polyfunctional polymerizable compound.

6. The decorative film for molding according to claim 1, comprising two or more cholesteric liquid crystal layers.

7. A decorative film for molding for use in an exterior of an automobile, comprising the decorative film for molding according to claim 1.

8. A decorative film for molding for use in a housing panel of an electronic device, comprising the decorative film for molding according to claim 1.

9. A method for manufacturing a decorative film for molding, the method comprising:
preparing a liquid crystal composition that includes, with respect to a total solid content of the liquid crystal composition, 25% by mass or more of a cholesteric liquid crystal compound having one ethylenic unsaturated group or one cyclic ether group;
applying the liquid crystal composition to a base material to form a liquid crystal composition layer; and
curing the liquid crystal composition layer to form a cholesteric liquid crystal layer.

10. A molded product obtained by molding the decorative film for molding according to claim 1.

11. A molding method, comprising molding the decorative film for molding according to claim 1.
